(19) United States
(12) Patent Application Publication
(10) Pub. No.: US 2025/0270443 A1
(43) Pub. Date: Aug. 28, 2025

(54) ORGANIC METAL COMPLEX SCINTILLATORS AND METHODS OF MAKING THE SAME

(71) Applicant: Florida State University Research Foundation, Inc., Tallahassee, FL (US)

(72) Inventors: Biwu Ma, Tallahassee, FL (US); Tunde B. Shonde, Tallahassee, FL (US)

(21) Appl. No.: 19/055,999

(22) Filed: Feb. 18, 2025

Related U.S. Application Data
(60) Provisional application No. 63/556,540, filed on Feb. 22, 2024.

(51) Int. Cl. C09K 11/06; C07F 3/06; C08K 5/00; C09K 11/02; G01T 1/202

(52) U.S. Cl. CPC C09K 11/06; C07F 3/06; C08K 5/0091; C09K 11/02; G01T 1/2023; C09K 2211/1007; C09K 2211/1014; C09K 2211/1029; C09K 2211/188

(57) ABSTRACT

Scintillation materials (and scintillators) and methods of fabricating the same are provided. The scintillators can be based on aggregate induced emission (AIE) organic metal halide complexes. With molecular sensitization, these organic metal complex scintillators not only exhibit good X-ray absorption due to the presence of metal halides as a main radiation absorber (or sensitizer), but also possess efficient and fast radioluminescence in the solid state, thanks to the AIE nature of organic compounds as light emitters.

### CROSS-REFERENCE TO RELATED APPLICATION

This application claims the benefit of U.S. Provisional Application Ser. No. 63/556,540, filed Feb. 22, 2024, the disclosure of which is hereby incorporated by reference in its entirety, including all figures, tables, and drawings.

### GOVERNMENT SUPPORT

This invention was made with government support under DMR-2204466 awarded by National Science Foundation. The government has certain rights in the invention.

### BACKGROUND

X-ray and other forms of high-energy radiation are of great importance in numerous fields, including medical diagnosis and treatment, space exploration, non-destructive product inspection, pulsar navigation, and so on. Scintillators, capable of converting these ionizing radiations to ultraviolet (UV)-visible light, find widespread use in radiation detection and imaging. To date, the most commonly used scintillators are based on inorganic crystals, such as PbWO₄, Bi₄Ge₃O₁₂, thallium doped CsI (CsI:Tl), and cerium doped YAlO₃ (YAlO₃:Ce). While these scintillation materials satisfy certain application requirements, many issues and challenges remain to be addressed, including brittle nature, hygroscopicity, time-consuming high-temperature synthesis, and long decay lifetimes, among others. Organic and plastic scintillators, (e.g., anthracene, stilbene, polyvinyl toluene, polystyrene) offer some advantages of being flexible and low cost with short decay lifetimes, making them valuable alternatives to inorganic scintillators in certain applications. However the low radiation hardness, poor thermal stability, and most importantly, weak radiation attenuation and low scintillation light yield, prevent widespread use of these predominately carbon-based scintillators.

### BRIEF SUMMARY

In view of the disadvantages of existing scintillation materials, new types of scintillation materials are desired that combine the advantages of inorganic and organic scintillators. Embodiments of the subject invention provide novel and advantageous scintillation materials (and scintillators) and methods of fabricating the same. The scintillators can be based on aggregate induced emission (AIE) organic metal halide complexes. With molecular sensitization, these organic metal complex scintillators not only exhibit good X-ray absorption due to the presence of metal halides, but also possess efficient and fast radioluminescence in the solid state, thanks to the AIE nature. The high absolute light yield, short radioluminescence decay, and low detection limit make this new class of scintillators advantageous for numerous applications. Embodiments can be used for the development of high performance and low cost scintillators based on earth-abundant organic metal complexes, while significantly expanding the range of low-cost, solution-processable scintillators.

In an embodiment, a scintillation material (or a scintillator) can comprise: an organic metal halide complex comprising AIE organic species and a metal halide (e.g., a high Z metal halide species) that may be covalently bonded to the AIE organic species. The metal halide can be (and/or act as) a (main) radiation absorber (or sensitizer), and/or the AIE organic species can be (and/or act as) a light emitter. The metal halide species can be represented by the formula MₐX_{b}, where M is a metal (e.g., Zn, Cu, Mn, Pb, Cd, etc.), X is a halogen (e.g., F, Cl, Br, I), and a and b are integers. For example, the metal halide species can be represented by the formula ZnX₂ (e.g., ZnCl₂). The organic metal halide complex can be represented by the formula (OMM)ₘ(MₐX_{b})ₙ (e.g., (OMM)ₘ(ZnX₂)ₙ, where OMM is an AIE organic molecule, and m and n are integers. For example, the AIE organic molecule can be 4-(4-(diphenylamino) phenyl)-1-(propyl)-pyridinium (TPA-PD). The organic metal halide complex can be (TPA-PD)₂ZnCl₂. The scintillation material can have any or all (or any combination) of the following features: a photoluminescence quantum efficiency (PLQE) of at least 65%; an absolute light yield of at least 13,423 photons per mega electron Volt (photon/MeV); a limit of detection of about 80 nanoGrays per second (nGyₐᵢᵣ/s) (or less); and a radioluminescence decay lifetime in a range of from 1 nanoseconds (ns) to 100 ns (or any value, about any value, or subrange contained therewithin) (e.g., 5.24 ns or about 5.24 ns).

In another embodiment, an X-ray imaging material can comprise a composite of a polymer and a scintillation material as disclosed herein (e.g., (TPA-PD)₂ZnCl₂). The polymer can be, for example, poly(methyl methacrylate) (PMMA). The scintillation material can include any or all (or any combination) of the features discussed in the previous paragraph. The scintillation can be present in the composite at a weight percentage in a range of from 5 wt % to 95% (or any value, about any value, or subrange contained therewithin) (e.g., 60 wt % or about 60 wt %).

In another embodiment, a method of fabricating a scintillation material (which comprises an organic metal halide complex can comprise: synthesizing an AIE organic molecule (e.g., via nitrogen-based x-deficient pyridine coupling to electron-rich triphenylamine through palladium-catalyzed Suzuki cross-coupling); mixing the AIE organic molecule with a metal halide in a solvent to obtain a precursor solution; and performing solvent layering of an organic liquid on the precursor solution to obtain the organic metal halide complex. The organic liquid can be a nitrile, such as acetonitrile. The solvent can be, for example, dimethyl sulfoxide (DMSO), though embodiments are not limited thereto. The metal halide species can be represented by the formula MₐX_{b}, where M is a metal (e.g., Zn, Cu, Mn, Pb, Cd, etc.), X is a halogen (e.g., F, Cl, Br, I), and a and b are integers. For example, the metal halide species can be represented by the formula ZnX₂ (e.g., ZnCl₂). The organic metal halide complex can be represented by the formula (OMM)ₘ(MₐX_{b})ₙ (e.g., (OMM)ₘ(ZnX₂)ₙ, where OMM is an AIE organic molecule, and m and n are integers. For example, the AIE organic molecule can be TPA-PD. The organic metal halide complex can be (TPA-PD)₂ZnCl₂. The scintillation material can have any or all (or any combination) of the following features: a photoluminescence quantum efficiency (PLQE) of at least 65%; an absolute light yield of at least 13,423 photon/MeV; a limit of detection of about 80 nGyₐᵢᵣ/s (or less); and a radioluminescence decay lifetime in a range of from 1 ns to 100 ns (or any value, about any value, or subrange contained therewithin) (e.g., 5.24 ns or about 5.24 ns).

### BRIEF DESCRIPTION OF DRAWINGS

FIG. 1a shows a synthetic scheme for the preparation of 4-(4-(diphenylamino)phenyl)-1-(propyl)-pyridinium (TPA-PD).

FIG. 1b shows a synthetic scheme for the preparation of (TPA-PD)₂ZnCl₂.

FIG. 1c shows an image of TPA-PD under daylight.

FIG. 1d shows an image of (TPA-PD)₂ZnCl₂ under daylight.

FIG. 1e shows the molecular structure of TPA-PD.

FIG. 1f shows the molecular structure of (TPA-PD)₂ZnCl₂.

FIG. 1g shows molecular packing for TPA-PD. The gray represents carbon; the blue represents nitrogen; the light gray represents hydrogen. The orange to orange distance shows the π ⋅⋅⋅ π distances. Ellipsoids are drawn at their 50% probability level.

FIG. 1h shows molecular packing for (TPA-PD)₂ZnCl₂. The gray represents carbon; the blue represents nitrogen; the light gray represents hydrogen. The orange to orange distance shows the π ⋅⋅⋅π distances. Ellipsoids are drawn at their 50% probability level.

FIG. 2a shows plots of absorbance and emission spectra for TPA-PD (top plot), (TPA-PD)₂ZnCl₂ (middle plot), and Bis[2-(2-benzothiazolyl)phenolato]-zinc (II) (BBPZn) (bottom plot). The insets show the images of TPA-PD (top plot), (TPA-PD)₂ZnCl₂ (middle plot), and BBPZn (top plot) under a 365 nanometer (nm) ultraviolet (UV) lamp excitation.

FIG. 2b shows photoluminescence decay kinetics of TPA-PD (top plot), (TPA-PD)₂ZnCl₂ (middle plot), and BBPZn (bottom plot).

FIG. 3a shows a plot of computed effective Z versus photon energy (in mega electron Volts (MeV)) for TPA-PD, (TPA-PD)₂ZnCl₂, and BBPZn. The (blue) curve with the lowest effective Z values is for TPA-PD, the (green) curve with the second-lowest effect Z values is for (TPA-PD)₂ZnCl₂, and the (orange) curve with the highest effective Z values is for BBPZn.

FIG. 3b shows a plot of computed linear attenuation coefficient (in centimeter⁻¹ (cm⁻¹)) versus photon energy (in kilo electron Volts (keV)) for TPA-PD, (TPA-PD)2ZnCl2, and BBPZn. The (blue) curve with the lowest linear attenuation coefficient value at 100 keV is for TPA-PD, the (green) curve with the second-lowest linear attenuation coefficient value at 100 keV is for (TPA-PD)₂ZnCl₂, and the (orange) curve with the highest linear attenuation coefficient value at 100 keV is for BBPZn.

FIG. 3c shows radioluminescence spectra of TPA-PD (top plot), (TPA-PD)₂ZnCl₂ (middle plot) and BBPZn (bottom plot).

FIG. 3d shows radioluminescence decay kinetics of TPA-PD (top plot), (TPA-PD)₂ZnCl₂ (middle plot) and BBPZn (bottom plot).

FIG. 4a shows a comparison of light yield (in photons/MeV) of reported scintillators based on metal organic complex.

FIG. 4b shows a plot of radioluminescence (RL) intensity (in 10⁷ counts per second (cps)) versus dose rate (in microGrays per second (μGyₐᵢᵣ/s), showing the dose-response linearity measurement of (TPA-PD)₂ZnCl₂.

FIG. 4c shows a plot of RL intensity (in arbitrary units (a.u.)) versus time (in seconds(s)), showing the emission radio-stability at 448 nm for the (TPA-PD)₂ZnCl₂ versus continuous irradiation (top) and repeated on-off cycles of X-rays (bottom) at a dose rate of 221.39 μGy/s.

FIG. 4d shows an image of an encapsulated metallic spring.

FIG. 4e shows an image of an electronic circuit.

FIG. 4f shows an X-ray image of the encapsulated spring from FIG. 4d.

FIG. 4g shows an X-ray image of electronic circuit from FIG. 4e.

FIG. 5 shows the molecular structure of (TPA-PD)₂ZnCl₂.

FIG. 6 shows ¹H nuclear magnetic resonance (NMR) spectroscopy characterization of TPA-PD.

FIG. 7 shows ¹H nuclear magnetic resonance (NMR) spectroscopy characterization of (TPA-PD)₂ZnCl₂.

FIG. 8 shows a comparison between experimental and simulated powder X-ray diffraction (PXRD) patterns of (TPA-PD)₂ZnCl₂. The (blue) curve that is higher in the plot is for experimental, and the (gray) curve that is lower in the plot is for simulated.

FIG. 9a shows thermogravimetric and differential scanning calorimetric analysis of TPA-PD. The (gray) curve that is higher in the plot at 100° C. is for weight, and the (red) curve that is lower in the plot at 100° C. is for heat flow.

FIG. 9b shows thermogravimetric and differential scanning calorimetric analysis of (TPA-PD)₂ZnCl₂. The (gray) curve that is higher in the plot at 100° C. is for weight, and the (red) curve that is lower in the plot at 100° C. is for heat flow.

FIG. 9c shows thermogravimetric and differential scanning calorimetric analysis of BBPZn. The (gray) curve that is higher in the plot at 100° C. is for weight, and the (red) curve that is lower in the plot at 100° C. is for heat flow.

FIG. 10a shows a plot of intensity (in cps) versus wavelength (in nm), showing photoluminescence quantum yield of TPA-PD. The (gray) curve with the lower intensity value at a wavelength of 500 nm is for reference, and the (red) curve with the higher intensity value at a wavelength of 500 nm is for sample.

FIG. 10b shows a plot of intensity (in cps) versus wavelength (in nm), showing photoluminescence quantum yield of (TPA-PD)₂ZnCl₂. The (gray) curve with the lower intensity value at a wavelength of 500 nm is for reference, and the (red) curve with the higher intensity value at a wavelength of 500 nm is for sample.

FIG. 10c shows a plot of intensity (in cps) versus wavelength (in nm), showing photoluminescence quantum yield of BBPZn. The (gray) curve with the lower intensity value at a wavelength of 500 nm is for reference, and the (red) curve with the higher intensity value at a wavelength of 500 nm is for sample.

FIG. 11a shows a plot of mass absorption coefficient (in square centimeters per gram (cm²/g)) versus photon energy (in MeV) for TPA-PD, (TPA-PD)₂ZnCl₂, and BBPZn. The (blue) curve with the lowest mass absorption coefficient value at a photon energy of 10⁻¹ MeV is for TPA-PD, the (green) curve with the second-lowest mass absorption coefficient value at a photon energy of 10⁻¹ MeV is for (TPA-PD)₂ZnCl₂, and the (orange) curve with the highest mass absorption coefficient value at a photon energy of 10⁻¹ MeV is for BBPZn.

FIG. 11b shows a plot of attenuation efficiency (in percentage (%)) versus thickness (in centimeters (cm)) at an X-ray energy of 39.2 keV for TPA-PD, (TPA-PD)₂ZnCl₂, and BBPZn. The (blue) curve with the lowest attenuation efficiency values is for TPA-PD, the (green) curve with the second-lowest attenuation efficiency values is for (TPA-PD)₂ZnCl₂, and the (orange) curve with the highest attenuation efficiency values is for BBPZn.

FIG. 11c shows a plot of attenuation efficiency (in percentage (%)) versus thickness (in centimeters (cm)) at an X-ray energy of 10.3 keV for TPA-PD, (TPA-PD)₂ZnCl₂, and BBPZn. The (blue) curve with the lowest attenuation efficiency values is for TPA-PD, the (green) curve with the second-lowest attenuation efficiency values is for (TPA-PD)₂ZnCl₂, and the (orange) curve with the highest attenuation efficiency values is for BBPZn.

FIG. 12a shows a plot of counts (in a.u.) versus channel number for TPA-PD, (TPA-PD)₂ZnCl₂, and BBPZn with a ¹³⁷Cs (cesium-137) excitation source. The (blue) curve with the lowest count value at channel number 200 is for TPA-PD, the (green) curve with the second-lowest count value at channel number 200 is for (TPA-PD)₂ZnCl₂, and the (orange) curve with the highest count value at channel number 200 is for BBPZn.

FIG. 12b shows a bar chart of absolute light yield (left y-axis; in 10³ photons per MeV) and number of photoelectrons (right y-axis; in 10³ photoelectrons per MeV) for TPA-PD, (TPA-PD)₂ZnCl₂, and BBPZn.

FIG. 13a shows PXRD data comparison of pellet and powder for TPA-PD.

FIG. 13b shows PXRD data comparison of pellet and powder for (TPA-PD)₂ZnCl₂.

FIG. 13c shows PXRD data comparison of pellet and powder for BBPZn.

FIG. 14a shows a plot of integrated radioluminescence (in 10⁷ cps) versus thickness (in millimeters (mm)) for TPA-PD.

FIG. 14b shows a plot of integrated radioluminescence (in 10⁷ cps) versus thickness (in mm) for (TPA-PD)₂ZnCl₂.

FIG. 14c shows a plot of integrated radioluminescence (in 10⁷ cps) versus thickness (in mm) for BBPZn.

FIG. 15a shows a plot of intensity (in 10⁵ cps) versus wavelength (in nm), showing radioluminescence spectra of TPA-PD under X-ray excitation dose rate from 3.08 μGyₐᵢᵣ/s to 221.39 μGyₐᵢᵣ/S.

FIG. 15b shows a plot of intensity (in 10⁵ cps) versus wavelength (in nm), showing radioluminescence spectra of (TPA-PD)₂ZnCl₂ under X-ray excitation dose rate from 3.08 μGyₐᵢᵣ/s to 221.39 μGyₐᵢᵣ/S.

FIG. 15c shows a plot of intensity (in 10⁵ cps) versus wavelength (in nm), showing radioluminescence spectra of BBPZn under X-ray excitation dose rate from 3.08 μGyₐᵢᵣ/s to 221.39 μGyₐᵢᵣ/S.

FIG. 16a shows a plot of RL intensity (in 10⁷ cps) versus dose rate (in μGyₐᵢᵣ/s), showing integrated radioluminescence spectra of TPA-PD.

FIG. 16b shows a plot of RL intensity (in 10⁷ cps) versus dose rate (in μGyₐᵢᵣ/s), showing integrated radioluminescence spectra of BBPZn.

FIG. 17a shows a plot of radiation stability of TPA-PD under continuous irradiation (221.39 μGyₐᵢᵣ/s) for 30 minutes.

FIG. 17b shows a plot of radiation stability of BBPZn under continuous irradiation (221.39 μGyₐᵢᵣ/s) for 30 minutes.

FIG. 18a shows an image of a 60 weight percentage (60 wt %) (TPA-PD)₂ZnCl_{2.}-poly(methyl methacrylate) (PMMA) composite. The scale bar is 4.0 mm.

FIG. 18b shows a schematic of an X-ray imaging setup.

FIGS. 19a-19e show X-ray images of an encapsulated spring under various X-ray dose rates. FIG. 19a is under 40 kilovolt (kV), 100 microamp (μA) X-ray irradiation; FIG. 19b is under 40 kV, 60 μA X-ray irradiation; FIG. 19c is under 40 kV, 40 μA X-ray irradiation; FIG. 19d is under 20 kV, 100 μA X-ray irradiation; and FIG. 19e is under 40 kV, 20 μA X-ray irradiation. The scale bar is 5.8 mm.

FIG. 20 shows a table of single crystal structure data of (TPA-PD)₂ZnCl₂.

FIG. 21 shows a table of selected bond distance and angles of (TPA-PD)₂ZnCl₂.

FIG. 22 shows a table of fitting parameters for photoluminescent (PL) decay kinetics of BBPZn, TPA-PD, and (TPA-PD)₂ZnCl₂.

FIG. 23 shows a plot of a figure of merit for reported scintillators based on metal-organic complexes. The “Ref” column indicates the source for the scintillator. A value of “1” indicates it is from Zhou et al. (Highly Luminescent Nonclassical Binuclear Manganese(II) Complex Scintillators for Efficient X-ray Imaging, Inorg Chem 62, 5729-5736, 2023; which is hereby incorporated by reference herein in its entirety); a value of “2” indicates it is from Meng et al. (Highly Emissive and Stable Five-Coordinated Manganese(II) Complex for X-Ray Imaging, Laser and Photonics Reviews 15, 2100309, 2021; which is hereby incorporated by reference herein in its entirety); a value of “3” indicates it is from Liu et al. (Rational design and synthesis of scintillating lanthanide coordination polymers for highly efficient X-ray imaging, Journal of Materials Chemistry C 11, 7405-7410, 2023; which is hereby incorporated by reference herein in its entirety); a value of “4” indicates it is from Boatner et al. (New cerium-based metal-organic scintillators for radiation detection, Nuclear Instruments and Methods in Physics Research Section A: Accelerators, Spectrometers, Detectors and Associated Equipment 703, 138-144, 2013; which is hereby incorporated by reference herein in its entirety); a value of “5” indicates it is from Chen et al. (Triplet Exciton Enhanced Radioluminescence of Ga³⁺/Tb³⁺ Metallacrown Scintillators for X-Ray Detection, Advanced Optical Materials 10, 2102074, 2021; which is hereby incorporated by reference herein in its entirety); and value of “This work” indicates it is a material described herein.

FIG. 24 shows a table of experimental dose rate.

### DETAILED DESCRIPTION

Embodiments of the subject invention provide novel and advantageous scintillation materials (and scintillators) and methods of fabricating the same. The scintillators can be based on aggregate induced emission (AIE) organic metal halide complexes. With molecular sensitization, these organic metal complex scintillators not only exhibit good X-ray absorption due to the presence of high Z metal halides, but also possess efficient and fast radioluminescence in the solid state, thanks to the AIE nature. The high absolute light yield, short radioluminescence decay, and low detection limit make this new class of scintillators advantageous for numerous applications. Embodiments can be used for the development of high performance and low cost scintillators based on earth-abundant organic metal complexes, while significantly expanding the range of low-cost, solution-processable scintillators.

Scintillators are widely used in many technical areas, ranging from healthcare to homeland security and industrial product inspection. Various types of scintillation materials have been developed over the years, including rare-earth doped inorganic crystals, pure organic compounds, polymers, and more recently metal halide perovskites and hybrids. Embodiments of the subject invention provide a new class of scintillation materials based on organic metal halide complexes with AIE, which can be facilely synthesized and processed in solution phase. By taking advantages of high X-ray absorption of metal halides and fast radioluminescence of AIE molecules, covalently bonded organic metal halide complexes can be fabricated as new generation scintillators with numerous applications for radiation detection and imaging.

Embodiments of the subject invention can use organic metal halide complexes with AIE for X-ray scintillation, which can be facilely synthesized and processed in the solution phase. An AIE organic molecule, 4-(4-(diphenylamino)phenyl)-1-(propyl)-pyridinium (TPA-PD), can be reacted with zinc chloride (ZnCl₂) in solution at room temperature. This can give an organic metal halide complex, (TPA-PD)₂ZnCl₂ (at a high yield, such as at least 80%, at least 85%, at least 87%, about 87%, 87%, at least 90%, at least 95%, or at least 99%). Optical and radioluminescence characterizations find that (TPA-PD)₂ZnCl₂ exhibits bluish-green photoluminescence and radioluminescence peaked at around 450 nanometers (nm), with a photoluminescence quantum efficiency (PLQE) of at least 65% and an absolute light yield of at least 13,423 photons per mega electron Volt (photon/MeV). Short photoluminescence and radioluminescence decay lifetimes (e.g., 1.81 nanoseconds (ns) (or about 1.81 ns) and 5.24 ns (or about 5.24 ns), respectively). For X-ray scintillation, an excellent response dose-response linearity and a low limit of detection (e.g., 80.23 nanoGrays per second (nGyₐᵢᵣ/s) or about 80 nGyₐᵢᵣ/s) can be obtained for (TPA-PD)₂ZnCl₂. By taking advantage of the high X-ray absorption of metal halides and fast radioluminescence of AIE molecules, the covalently bonded organic metal halide complexes of embodiments of the subject invention open up new opportunities for the development of high-performance solution-processable scintillators.

In order to overcome the low X-ray absorption capability of organic scintillators, molecular sensitization of luminescent organic components by high-Z components can be an effective approach in various types of material systems. Physically blending luminescent organic molecules with high-Z oxides, metal complexes, and halide perovskites can enhance the X-ray absorption of hybrid composite systems. However, the non-uniformity of the blends, as well as the inferior energy/charge transfer between high-Z components and organic molecules, limit the overall performance. Chemically bonding organic units with high-Z components can produce scintillation materials with much better performance than those of blends ([1], [19], [20]). These organic metal halide hybrid scintillators can provide significantly improved X-ray absorption and radioluminescence compared to pure organic molecules. However, the ionic nature of organic metal halide hybrids may limit their processability.

Organic metal complexes, in which organic ligands are covalently bonded to metal ions, have a wide range of applications, from catalysis to electronics, photonics, and medicines. However, their potential as scintillators has been underexplored, with cerium-and lanthanide-based organic metal complexes that exhibit low light yields ([22], [23]). Also, the presence of heavy atoms in these organic metal complexes often leads to long-lived phosphorescent emissions, which is undesirable for dynamic X-ray imaging, high-energy particle physics research, and many other applications. Therefore, embodiments of the subject invention are motivated in part by further exploration of organic metal complexes to develop efficient, rapid, and solution-processable scintillators.

Embodiments of the subject invention provide organic metal halide complex scintillators with high absolute light yield and fast radioluminescence, which can be facilely prepared by reacting an AIE organic molecule (TPA-PD) with zinc chloride (ZnCl₂) in solution at room temperature. In this covalently bonded organic metal halide complex ((TPA-PD)₂ZnCl₂), the appropriate distance between the AIE active TPA-PD moieties and metal halides (ZnCl₂) enables efficient molecular sensitization with ZnCl₂ harvesting high energy radiation and charge transfer to the organic units. Additionally, zinc chloride modulates the intra-ligand emission by increasing molecular rigidity and suppressing non-radiative decays, leading to enhanced radioluminescence. (TPA-PD)₂ZnCl₂ is found to exhibit an absolute light yield of (at least) 13,423 Photon/MeV, which is more than 4.5 times higher than that of the pure AIE molecule (TPA-PD; 2980 Photon/MeV) and twice of that of a commercially available zinc complex (Bis[2-(2-benzothiazolyl)phenolato]-zinc (II) (BBPZn); 6249 Photon/MeV). (TPA-PD)₂ZnCl₂ also exhibits fast photoluminescence and radioluminescence decays with lifetimes in nanoseconds, an excellent dose linearity, and a low limit of detection (e.g., 80.23 nGyₐᵢᵣ/S).

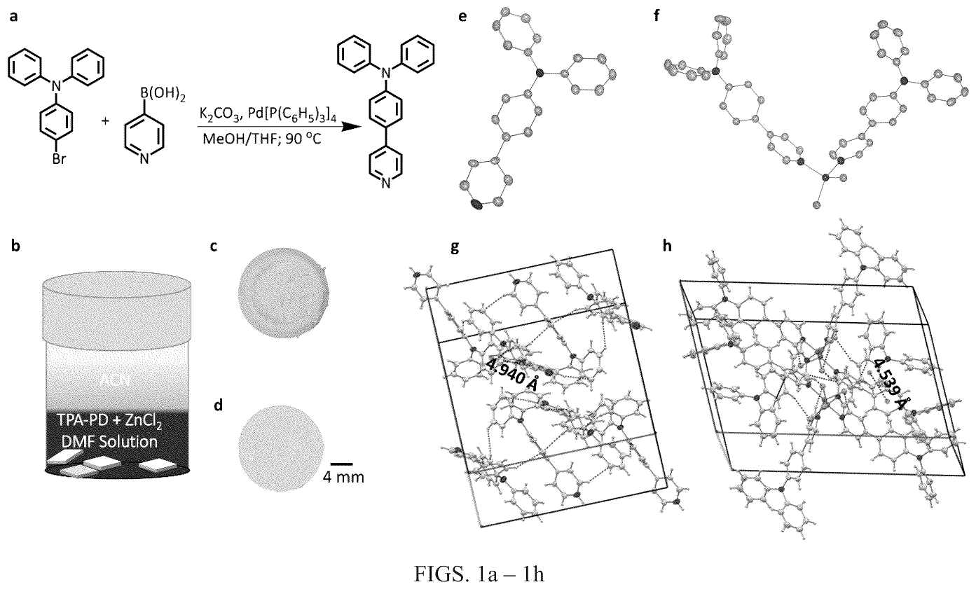

The synthetic procedures for the preparation of TPA-PD and TPA-PD)₂ZnCl₂ are shown in FIGS. 1a and 1b, respectively. TPA-PD was synthesized following a procedure in which nitrogen-based π-deficient pyridine was coupled to electron-rich triphenylamine through palladium-catalyzed Suzuki cross-coupling (see also; Ma et al., The AIE-Active Dual-Cationic Molecular Engineering: Synergistic Effect of Dark Toxicity and Phototoxicity for Anticancer Therapy, Advanced Functional Materials, 2106988, 2021; and Yin et al., Positive charge-dependent cell targeted staining and DNA detection, New Journal of Chemistry 43, 18251-18258, 2019; both of which are hereby incorporated herein by reference in their entireties).

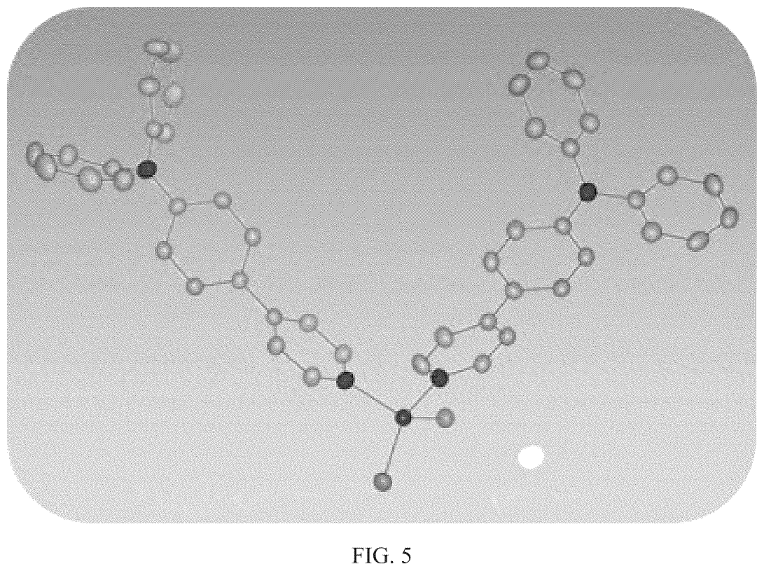

(TPA-PD)₂ZnCl₂ single crystals can be formed through solvent layering of acetonitrile on the precursor solution containing TPA-PD and ZnCl₂ (e.g., in a 2:1 molar ratio). Detailed descriptions of a specific synthesis, purification, and purity analysis can be found in the Materials and Methods section herein. FIGS. 1c and 1d show images of TPA-PD and (TPA-PD)₂ZnCl₂, respectively under ambient light with TPA-PD and (TPA-PD)₂ZnCl₂ displaying white and yellowish-white color, respectively. FIGS. 1e and 1f show the molecular structures of TPA-PD and (TPA-PD)₂ZnCl₂, respectively; and FIGS. 1g and 1h show molecular packing of TPA-PD and (TPA-PD)₂ZnCl₂, respectively. FIG. 5 shows an enlarged version of the molecular structure of (TPA-PD)₂ZnCl₂.

Embodiments of the subject invention provide efficient molecular scintillators based on the AIE organic zinc halide complex, (TPA-PD)₂ZnCl₂. This covalently bonded organic metal halide complex with molecular sensitization not only exhibits good X-ray absorption due to the presence of high Z metal halides, but also possesses efficient and fast radioluminescence in solid state, thanks to its AIE nature. The high absolute light yield of 13,423 photons/MeV, short radioluminescence decay lifetime of 5.24 ns, and low detection limit of 80.23 nGyₐᵢᵣ/s are among the best values achieved to date for molecular scintillators. These materials are promising for the development of high performance and low-cost scintillators based on earth-abundant organic metal complexes, and significantly expand the range of low-cost, solution-processable scintillators.

The phrases “C1-C20 hydrocarbyl,” and the like, as used herein, generally refer to aliphatic, aryl, or arylalkyl groups containing 1 to 20 carbon atoms. Examples of aliphatic groups, in each instance, include, but are not limited to, an alkyl group, a cycloalkyl group, an alkenyl group, a cycloalkenyl group, an alkynyl group, an alkadienyl group, a cyclic group, and the like, and includes all substituted, unsubstituted, branched, and linear analogs or derivatives thereof, in each instance having 1 to about 20 carbon atoms. Examples of alkyl groups include, but are not limited to, methyl, ethyl, propyl, isopropyl, n-butyl, t-butyl, isobutyl, pentyl, hexyl, isohexyl, heptyl, 4,4-dimethylpentyl, octyl, 2,2,4-trimethylpentyl, nonyl, decyl, undecyl and dodecyl. Cycloalkyl moieties may be monocyclic or multicyclic, and examples include cyclopropyl, cyclobutyl, cyclopentyl, cyclohexyl, and adamantyl. Additional examples of alkyl moieties have linear, branched and/or cyclic portions (e.g., 1-ethyl-4-methyl-cyclohexyl). Representative alkenyl moieties include vinyl, allyl, 1-butenyl, 2-butenyl, isobutylenyl, 1-pentenyl, 2-pentenyl, 3-methyl-1-butenyl, 2-methyl-2-butenyl, 2,3-dimethyl-2-butenyl, 1-hexenyl, 2-hexenyl, 3-hexenyl, 1-heptenyl, 2-heptenyl, 3-heptenyl, 1-octenyl, 2-octenyl, 3-octenyl, 1-nonenyl, 2-nonenyl, 3-nonenyl, 1-decenyl, 2-decenyl and 3-decenyl. Representative alkynyl moieties include acetylenyl, propynyl, 1-butynyl, 2-butynyl, 1-pentynyl, 2-pentynyl, 3-methyl-1-butynyl, 4-pentynyl, 1-hexynyl, 2-hexynyl, 5-hexynyl, 1-heptynyl, 2-heptynyl, 6-heptynyl, 1-octynyl, 2-octynyl, 7-octynyl, 1-nonynyl, 2-nonynyl, 8-nonynyl, 1-decynyl, 2-decynyl and 9-decynyl. Examples of aryl or arylalkyl moieties include, but are not limited to, anthracenyl, azulenyl, biphenyl, fluorenyl, indan, indenyl, naphthyl, phenanthrenyl, phenyl, 1,2,3,4-tetrahydro-naphthalene, tolyl, xylyl, mesityl, benzyl, and the like, including any heteroatom substituted derivative thereof.

Unless otherwise indicated, the term “substituted,” when used to describe a chemical structure or moiety, refers to a derivative of that structure or moiety wherein (i) a multi-valent non-carbon atom (e.g., oxygen, nitrogen, sulfur, phosphorus, etc.) is bonded to one or more carbon atoms of the chemical structure or moiety (e.g., a “substituted” C4 hydrocarbyl may include, but is not limited to, diethyl ether moiety, a methyl propionate moiety, an N,N-dimethylacetamide moiety, a butoxy moiety, etc., and a “substituted” aryl C12 hydrocarbyl may include, but is not limited to, an oxydibenzene moiety, a benzophenone moiety, etc.) or (ii) one or more of its hydrogen atoms (e.g., chlorobenzene may be characterized generally as an aryl C6 hydrocarbyl “substituted” with a chlorine atom) is substituted with a chemical moiety or functional group such as alcohol, alkoxy, alkanoyloxy, alkoxycarbonyl, alkenyl, alkyl (e.g., methyl, ethyl, propyl, t-butyl), alkynyl, alkylcarbonyloxy (—OC(O)alkyl), amide (—C(O)NH-alkyl- or -alkylNHC(O)alkyl), tertiary amine (such as alkylamino, arylamino, arylalkylamino), aryl, aryloxy, azo, carbamoyl (—NHC(O)O-alkyl- or —OC(O)NH-alkyl), carbamyl (e.g., CONH2, as well as CONH-alkyl, CONH-aryl, and CONH-arylalkyl), carboxyl, carboxylic acid, cyano, ester, ether (e.g., methoxy, ethoxy), halo, haloalkyl (e.g., —CCl3, —CF3, —C(CF3)3), heteroalkyl, isocyanate, isothiocyanate, nitrile, nitro, oxo, phosphodiester, sulfide, sulfonamido (e.g., SO2NH2), sulfone, sulfonyl (including alkylsulfonyl, arylsulfonyl and arylalkylsulfonyl), sulfoxide, thiol (e.g., sulfhydryl, thioether) or urea (—NHCONH-alkyl-).

While certain aspects of conventional technologies have been discussed to facilitate disclosure of various embodiments, applicants in no way disclaim these technical aspects, and it is contemplated that the present disclosure may encompass one or more of the conventional technical aspects discussed herein.

The present disclosure may address one or more of the problems and deficiencies of known methods and processes. However, it is contemplated that various embodiments may prove useful in addressing other problems and deficiencies in a number of technical areas. Therefore, the present disclosure should not necessarily be construed as limited to addressing any of the particular problems or deficiencies discussed herein.

The terms “a,” “an,” and “the” are intended to include plural alternatives, e.g., at least one. For instance, the disclosure of “an antisolvent”, “a triaryl amine”, and the like, is meant to encompass one, or mixtures or combinations of more than one antisolvent, triaryl amine, and the like, unless otherwise specified.

When ranges are used herein, combinations and subcombinations of ranges (e.g., any subrange within the disclosed range) and specific embodiments therein are intended to be explicitly included. When the term “about” is used herein, in conjunction with a numerical value, it is understood that the value can be in a range of 95% of the value to 105% of the value, i.e. the value can be +/−5% of the stated value. For example, “about 1 kg” means from 0.95 kg to 1.05 kg.

A greater understanding of the embodiments of the subject invention and of their many advantages may be had from the following examples, given by way of illustration. The following examples are illustrative of some of the methods, applications, embodiments, and variants of the present invention. They are, of course, not to be considered as limiting the invention. Numerous changes and modifications can be made with respect to embodiments of the invention.

### Materials and Methods

Materials: Zinc Chloride (99.999%), 4-bromotriphenylamine (97%), pyridine-4-boronic acid (90%), tetrakis(triphenylphosphine)-palladium(0), (99%), potassium carbonate (≥99.0%), tetrahydrofuran (THF, ≥99.9%), methanol (MeOH, ≥99.9%), dichloromethane (DCM, ≥99.8%), poly methylmethacylate (average molecular weight-120,000) were all purchased from Sigma Aldrich. N, N-Dimethylformamide (DMF ≥99.8%), and diethyl ether (Et₂O, ≥99.9%) were purchased from VWR. These materials were used without further purification after purchase. The elemental analysis was performed by Atlantic Microlab, Inc., Norcross, Georgia, USA.

Synthesis of N, N-diphenyl-4-(pyridin-4-yl) aniline (TPA-PD): 4-Bromotriphenylamine (7.4 mmol, 324.21 g/mol, 2.4 g), pyridine-4-boronic acid (12 mmol, 122.92 g/mol, 1.475 g), tetrakis(triphenylphosphine)-palladium (0) (0.297 mmol, 1155 g/mol, 0.344 g) and potassium carbonate (14.4 mmol, 138.21 g/mol, 2 g) were weighed into clean flask. This was followed by three cycles of repeated purging with N₂ and vacuum evacuation. A 120 ml of combined solvent (THF:MeOH; 1:1) of THF and MeOH was added with two cycles of purging with N₂ and vacuum evacuation. The mixture was refluxed at 90° C. for 36 hours under an N₂ atmosphere and then concentrated by rotary evaporation. TPA-PD was purified by column chromatography on silica gel with a mixture of petroleum ether and ethyl acetate as the eluent (7:1 by volume) to obtain about 55% TPA-PD white solid yield after recrystallization with DCM. Synthetic scheme can be found in Figure S1. ¹H NMR (600 MHz, DMF-D7) δ 8.65-8.61 (m, 2H), 7.82 (d, J=8.7 Hz, 2H), 7.75-7.71 (m, 2H), 7.44-7.37 (m, 4H), 7.19-7.13 (m, 6H), 7.11 (d, J=8.7 Hz, 2H).; HRMS (ESI) m/z: calc. value: 322.15; found 323.1567. Elemental analysis for TPA-PD (C₂₃H₁₈N₂) calculated: C, 85.68; H,5.63; N, 8.69. Found C, 84.86; H, 5.58; N, 8.69.

Synthesis of N,N-diphenyl-4-(pyridine-4-yl)aniline zinc (II) chloride (TPA-PD)₂ZnCl₂): 2:1 molar ratio of N,N-diphenyl-4-(pyridine-4-yl)aniline and zinc chloride were fully dissolved in the appropriate amount of DMF to form a precursor solution. This was followed by the addition of acetonitrile, 3× the volume of the precursor solution. Crystal formation of (TPA-PD)₂ZnCl₂) within a few hours to a day is observed. This is followed by washing with Et₂O, achieving about 87% yield of (TPA-P)₂ZnCl₂. Synthetic schematic can be found in Figure S2. ¹H NMR (600 MHz, DMF-D7) δ 8.69-8.65 (m, 2H), 7.90-7.84 (m, 4H), 7.41 (dd, J=8.4, 7.5 Hz, 4H), 7.17 (ddd, J=3.7, 3.0, 1.3 Hz, 6H), 7.11 (d, J=8.8 Hz, 2H). Elemental analysis for (TPA-PD)₂ZnCl₂ (C₄₆H₃₆N₄ZnCl₂); Calculated: C, 70.73; H, 4.65; N, 7.17; Cl, 9.08. Found: C, 70.50; H, 4.65; N, 7.42; Cl, 9.09.

Fabrication of X-ray imaging scintillator film: 120 mg of (TPA-PD)₂ZnCl₂ crystals were initially partially dissolved in 0.5 ml of chloroform. To ensure thorough mixing, the solution was vortex-mixed and sonicated for a period of 2 hours. Following the dissolution of the crystals, 80 mg of poly(methyl methacrylate) (PMMA) was added to the solution. This mixture was then subjected to an additional 2 hours of sonication. Once this step was complete, the resulting solution was further stirred using a magnetic stirrer for a duration of 30 minutes. To prepare the substrate for film deposition, an ozone cleaned glass surface was utilized. The well mixed and homogenized slurry was carefully drop-cast onto the glass substrate and allowed to dry for 24 hours. It is noteworthy that during the drying process, a beaker housing was used to cover the substrate. This precaution was taken to ensure the film's uniformity and quality.

### Structural Characterization

Single-crystal X-ray data for (TPA-P)₂ZnCl₂ was collected using a Rigaku XtaLAB Synergy-S diffractometer equipped with a HyPix-6000HE Hybrid Photon Counting (HPC) detector and dual Mo and Cu microfocus sealed X-ray source at 150 K. The powder X-ray diffraction (XRD) patterns were obtained using a Rigaku Smartlab powder diffractometer equipped with a Cu Kα X-ray source. Diffraction patterns were recorded from 5° to 50° 2θ with a step size of 0.05° under a tube current of 44 mA and tube voltage of 40 kV at room temperature. Further structural analysis of TPA-PD was done using ¹H B500 NMR equipped with a high resolution 5 mm TXI (H-C/N-D) Zg probe. Mass spectrometry was performed using liquid chromatography-time-of-flight/mass spectrometry (LC-TOF/MS) (TOF 6230, LC 1260, Agilent) in a positive electrospray ionization (ESI) mode with a mass range of 100-1700 m/z.

### Optical Characterization

Excitation and steady-state photoluminescence were carried out using an Edinburgh FS5 steady state spectrometer with a 150 W xenon lamp. Time-Correlated Single Photon Counting (TCSPC) was performed for 10,000 counts using excitation from an Edinburgh EPL-360 picosecond pulsed diode laser. The PL decay was fitted using a biexponential decay function for TPA-PD and (TPA-PD)₂ZnCl₂ and a mono-exponential decay function for BBPZn. The weighted average lifetime was computed according to equation (1).

$${τ}_{a v g} = \frac{\sum {α}_{i} {τ}_{i}^{2}}{\sum {α}_{i} {τ}_{i}} \qquad ( 1 )$$

where τᵢ represents the decay time, and αᵢ represents the amplitude of each component. PLQY measurement was performed using Hamamatsu Quantaurus-QY Spectrometer (Model C11347-11) equipped with a xenon lamp, an integrating sphere sample chamber, and a CCD detector. The PLQYs were calculated using the equation;

$$η Q E = \frac{{I}_{s}}{E {S}_{R} - E {S}_{s}} \qquad ( 2 )$$

where Iₛ stands for the photoluminescence emission spectrum of the sample, and ES_{S} and ES_{R} represent the excitation spectrum for the sample and reference, respectively.

### Thermal Stability Analysis

DSC studies were done using a TA instruments Q600 system. The sample was heated from room temperature to 700° C. at a 5° C./min rate under an argon flux of 100 mL/min.

### Radioluminescence Spectrum

The RL spectra were acquired using an Edinburgh FS5 spectrofluorometer (Edinburgh Instruments) equipped with an X-ray source (Moxtek Mini-X tube with a W target and 4 W maximum power output, see Table S5 for voltage, current X-ray dose relationship). The X-ray response intensity was examined and collected by a Hamamatsu R928 PMT. The radiation dose rate of the X-ray source was calibrated by using RaySafe 452 dosimeter. The pulse height spectra of a 137Cs were collected using a standard bialkali Hamamatsu R2059 photomultiplier tube connected to Canberra 2005 pre-amplifier, Ortec 672 spectroscopy amplifier, and a Tukan 8K multichannel analyzer. A shaping time of 10 μs was used to ensure complete light collection. The absolute light yield in photons per MeV was measured via the single photoelectron technique using a factory measured quantum efficiency R2059 PMT.

To determine the Limit of detection (LOD), series of the background signals were recorded without the sample under X-ray irradiation under 3.08 μGy/s to 221.39 μGy/s measurement. Then, a series of signal responses were taken with the sample under the above conditions, and the slope was determined. The LOD was calculated using the equation below, where Bkstd is the standard deviation of the background responses (see also Wang et al., Organic phosphors with bright triplet excitons for efficient X-ray-excited luminescence, Nature Photonics 15, 187-192, 2021; which is hereby incorporated by reference herein in its entirety).

$$LOD = \frac{3 * B {k}_{s t d}}{Slope} \qquad ( 3 )$$

### X-Ray Imaging

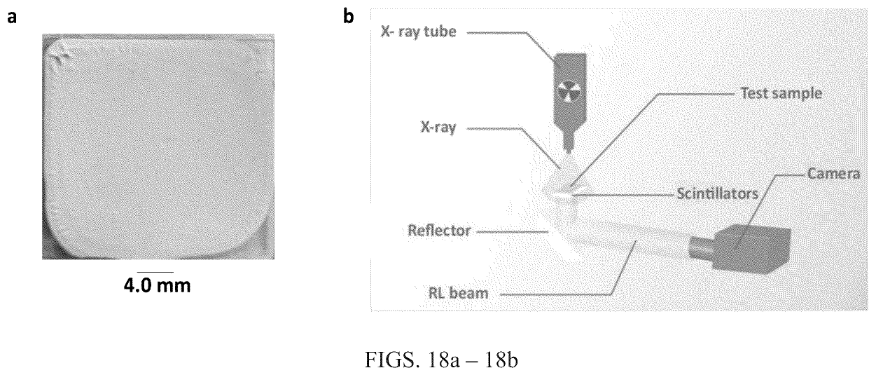

The X-ray imaging system was a lab-built X-ray imaging system, as seen in FIG. 18b, comprising an X-ray, a sample holder, a light ray reflector, and a digital camera. The X-ray source used in the imaging was a Moxtek Mini-X tube with a W target and 4 W maximum power output. In this built imaging system, the X-ray beam passed vertically through the object of interest, and the scintillator film, right below it. The optical path of resulting radioluminescence was then deflected towards the camera by a reflector angled at the imaging system to remove the negative effect caused by direct X-ray irradiation of the camera. A digital camera was used to captures the deflected image and saved in jpeg format.

### Example 1

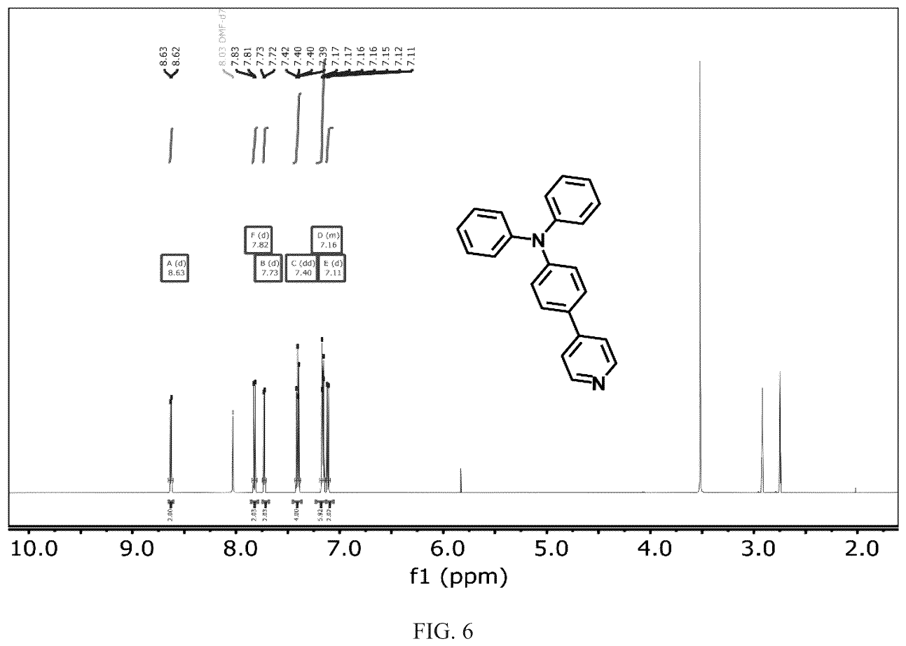

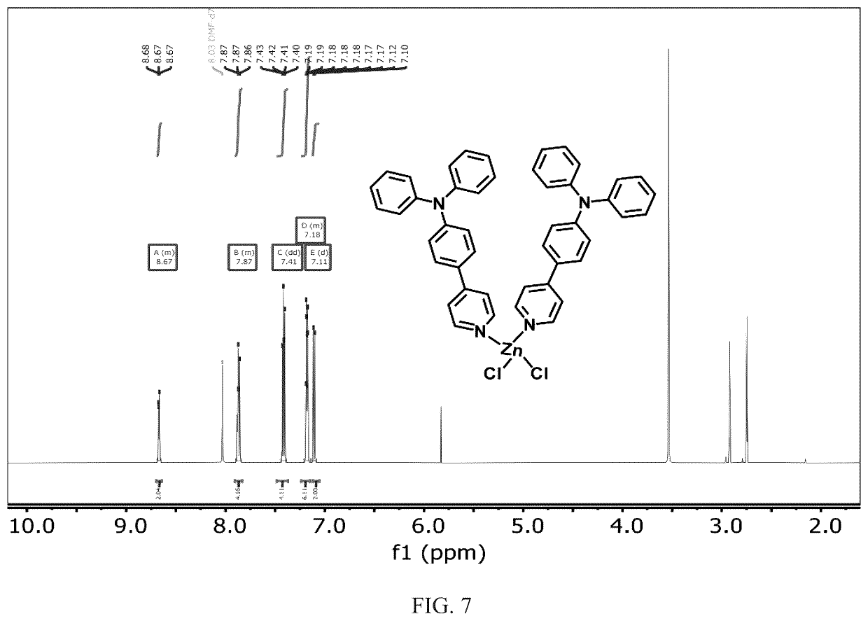

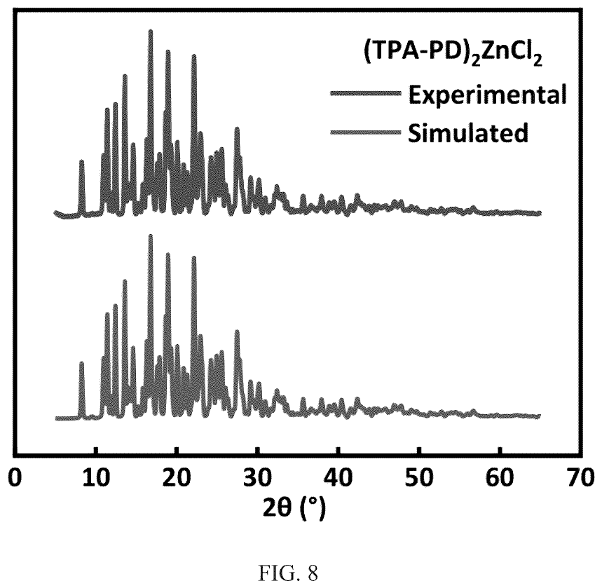

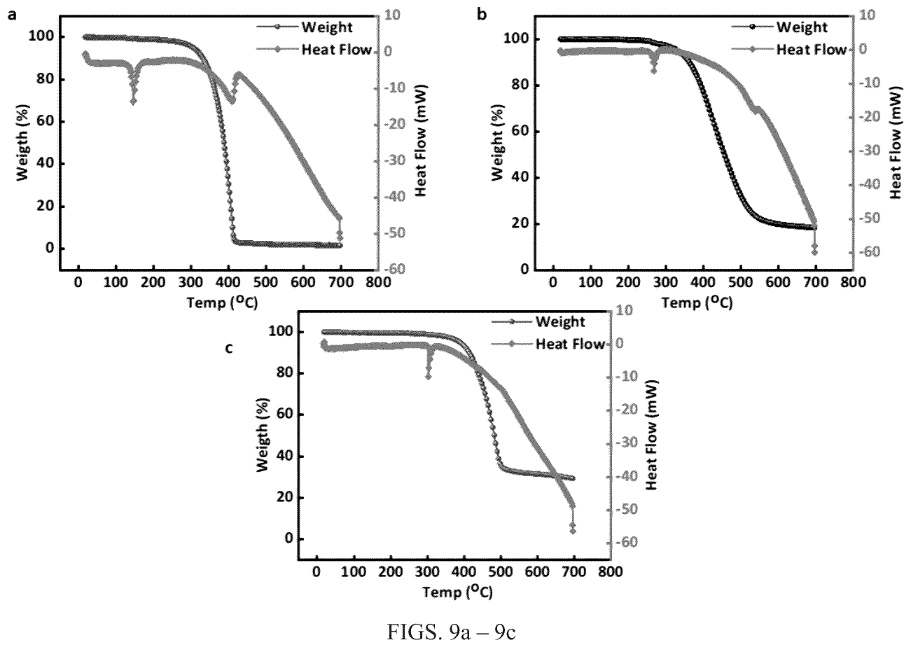

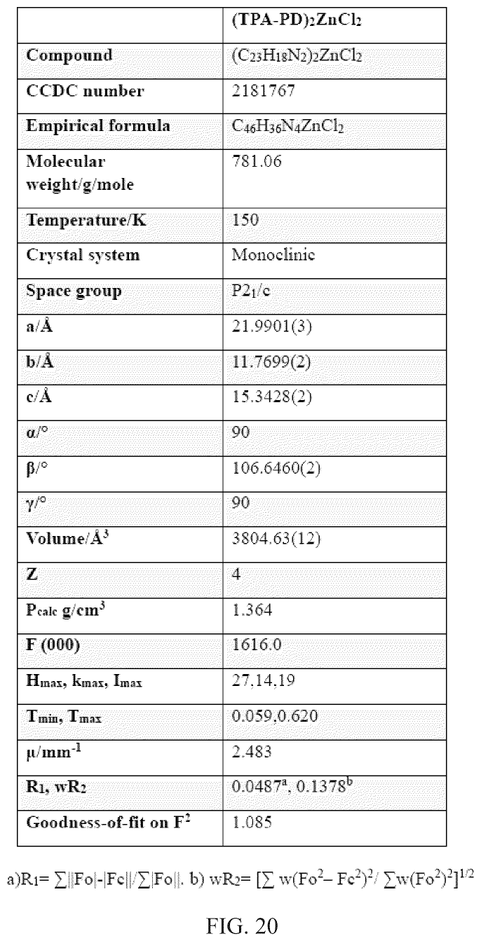

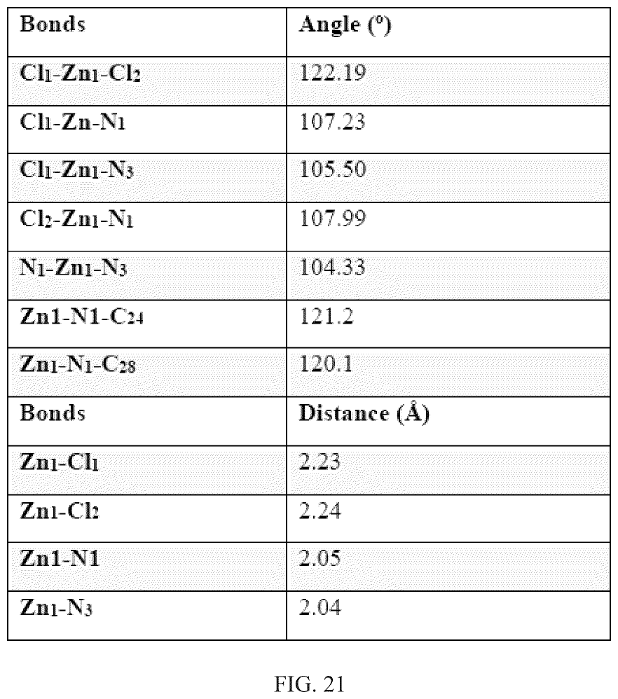

The composition and structure of TPA-PD and (TPA-PD)₂ZnCl₂ were fully characterized by elemental analysis, mass spectroscopy, ¹H NMR (see FIGS. 6 and 7), and powder (see FIG. 8) and single crystal X-ray diffraction. The single crystal structures and molecular packings of TPA-PD and (TPA-PD)₂ZnCl₂ are shown in FIGS. 1g and 1h, respectively. Detailed crystallographic information can be found in the tables in FIGS. 20 and 21. Selected angles and bonds are given in the table in FIG. 21. It was found that the Zn core is coordinated with two TPA-PD moieties and two chlorides in a distorted tetrahedral geometry, in which the average Zn—N and Zn—Cl distances are 2.044 Å and 2.235 Å, respectively. (TPA-PD)₂ZnCl₂ crystallizes into a monoclinic p21/c space group with a unit cell volume of 3804.6 cubic Angstroms (Å³) and density of 1.364 grams per cubic centimeter (g/cm³). TPA-PD crystallizes into C 2/c space group, and has a cell volume 3342.4 Å³ and density, 1.281 g/cm³. Both TPA-PD and (TPA-PD)₂ZnCl₂ essentially show similar molecular packings with the shortest π ⋅⋅⋅ π distance of 4.940 Å in TPA-PD and 4.539 Å in (TPA-PD)₂ZnCl₂, suggesting little-to-no π ⋅⋅⋅ π interactions. Additionally, there is a close CH-π proximity in both molecules with shortest distances of 2.820 Å and 2.861 Å for TPA-PD and (TPAPD)₂ZnCl₂, respectively, which hinders the intermolecular rotation. In order to assess the thermal properties of these compounds, thermogravimetric analysis (TGA) and differential scanning calorimetry (DSC) were performed with results shown in FIGS. 9a-9c. Onset weight loss is observed for TPA-PD and (TPA-PD)₂ZnCl₂ at 300° C. and 326° C., respectively. The thermogram from the DSC reveals the melting point peak apex of TPA-PD and (TPA-PD)₂ZnCl₂ to be 145° C. and 267° C., with full width at half maximum (FWHM) of about 7° C. and 5° C., respectively. The small FWHM (<10 K) indicates the materials are pure crystalline solids. The commercially available organic zinc complex BBPZn has an onset weight loss and melting temperature of 414° C. and 303° C., respectively.

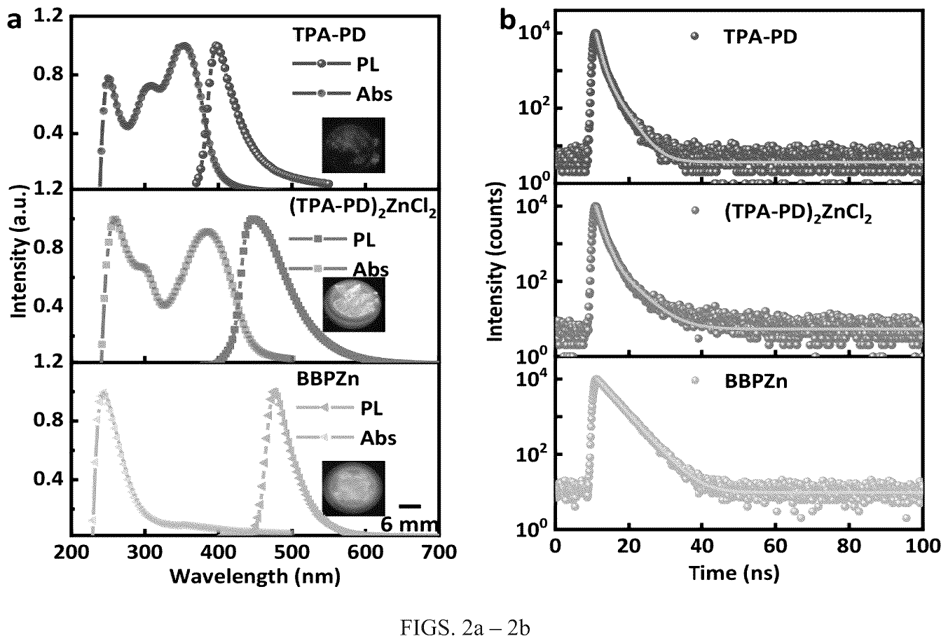

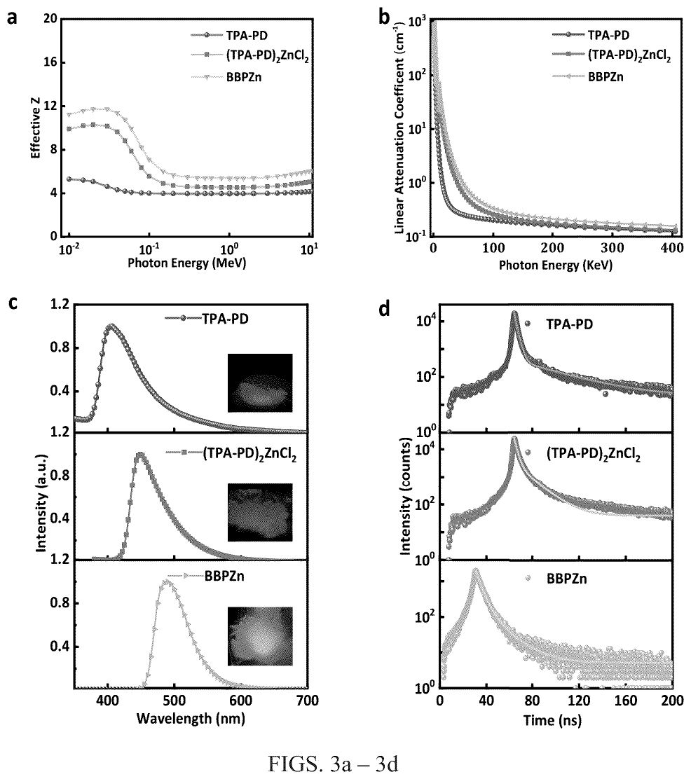

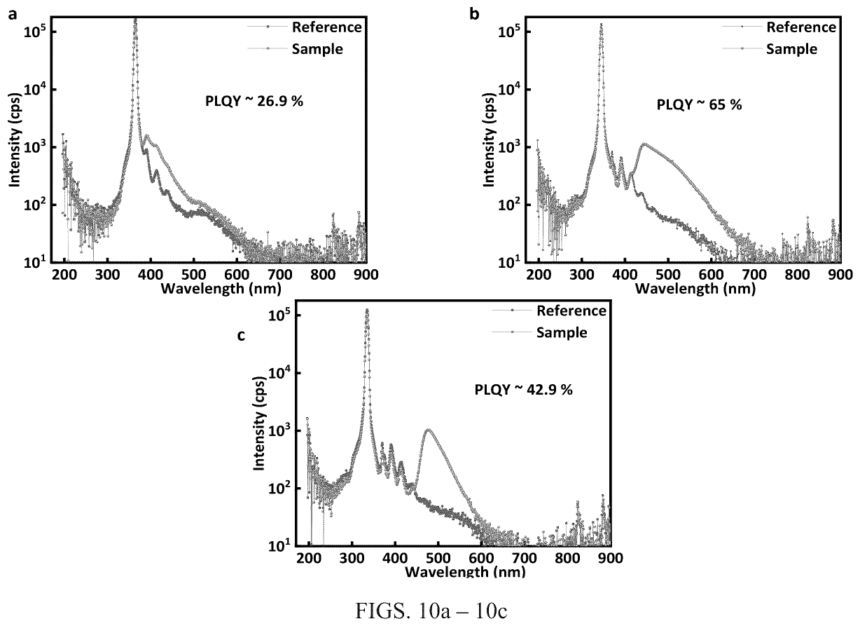

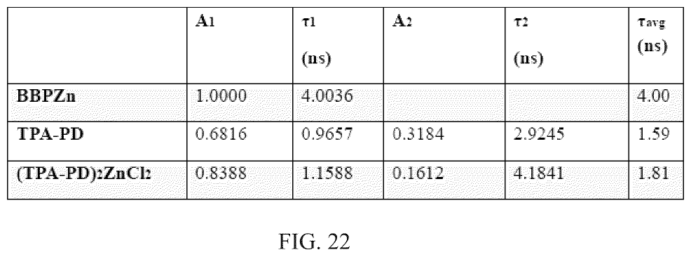

The photophysical properties of TPA-PD and (TPA-PD)₂ZnCl₂ were characterized with their absorption, emission, and decay dynamics shown in FIGS. 2a and 2b. Both TPA-PD and (TPA-PD)₂ZnCl₂ were found to possess similar broad absorption bands with three peaks, corresponding to the transitions occurring at the triphenylamine and pyridine moieties in the organic ligands. With photoexcitation at 365 nm, TPA-PD and (TPA-PD)₂ZnCl₂ exhibit deep blue and greenish-blue emissions, respectively. Their emission spectra show peaks at 398 nm and 448 nm with full width at half maximums (FWHMs) of 47 nm and 67 nm, respectively. These featureless emissions are attributed to the Intramolecular Charge Transfer (ICT) between the triphenylamine and pyridine moieties, a phenomenon in push-pull chromophore systems (see also Xiong et al., Achieving Tunable Organic Afterglow and UV Irradiation-Responsive Ultralong Room-Temperature Phosphorescence from Pyridine-Substituted Triphenylamine Derivatives, Advanced Materials, 2023; which is hereby incorporated by reference herein in its entirety). The slightly redshifted absorption and emission spectra of (TPA-PD)₂ZnCl₂ as compared to those of TPA-PD are believed to be caused by the perturbation of the ICT states with the binding of the Zn metal. The reference organic zinc complex BBPZn displays narrower featureless absorption and emission spectra with peaks at 244 nm and 475 nm. The insets of FIG. 3a show the images of three compounds under a 365 nm UV lamp excitation. The PLQEs of these compounds in solid state were determined to be 27%, 65%, and 42% for TPA-PD, (TPA-PD)₂ZnCl₂, and BBPZn, respectively (see also FIGS. 10a-10c). The higher PLQE of (TPA-PD)₂ZnCl₂ than that of TPA-PD is likely attributed to the increased molecular rigidity with suppression of nonradiative decays. The photoluminescence decay kinetics of these compounds were investigated using Time-Resolved Photoluminescence (TRPL) spectroscopy. As shown in FIG. 2b and the table in FIG. 22, both TPA-PD and (TPA-PD)₂ZnCl₂ show bi-exponential decays with average lifetimes of 1.59 ns and 1.81 ns, respectively. The similar decay kinetics are not surprising as TPA-PD and (TPA-PD)₂ZnCl₂ are both AIE compounds with emissions from the same ICT state. On the other hand, BBPZn shows a mono-exponential decay with a lifetime of 4.00 ns.

### Example 2

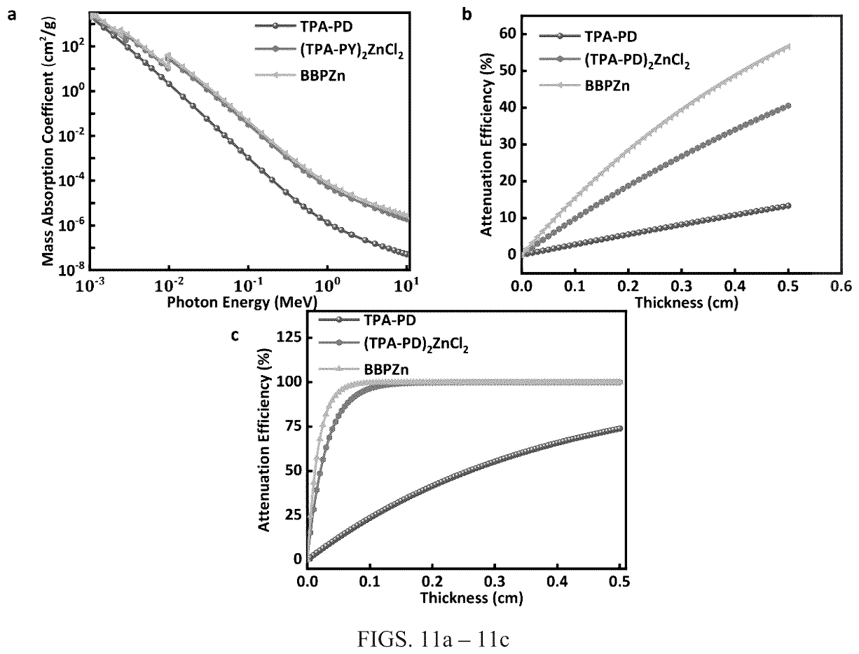

The potential of the three compounds, TPA-PD, (TPA-PD)₂ZnCl₂, and BBPZn, for X-ray scintillation was evaluated. First, the effective Z values and linear absorption coefficients in term of photon energy were determined for all the three compounds, as shown in FIGS. 3a and 3b. Across the studied photon energy range, the effective Z of (TPA-PD)₂ZnCl₂ is much higher than that of TPA-PD, but slightly lower than that of BBPZn. The theoretical linear absorption coefficients of (TPA-PD)₂ZnCl₂ and BBPZn are similar, which are much higher than that of TPA-PD. FIG. 11a shows the mass absorption coefficient versus photon energy plot. FIGS. 11b and 11b display the X-ray attenuation efficiency versus thickness at 39.2 keV and 10.3 keV X-ray photon, respectively. As can be seen, at 0.1 cm thickness, (TPA-PD)₂ZnCl₂ and BBPZn can attenuate 100% of 10.3 KeV, while more than 0.5 cm of TPA-PD is required to attenuate similarly. These results plainly show that integrating high Z atoms with hydrocarbon based organic molecules improves X-ray absorption. The radioluminescence (RL) properties of the three compounds were characterized. As shown in the insets of FIG. 3c, TPA-PD, (TPA-PD)₂ZnCl₂ and BBPZn, exhibit visible radioluminescence with excitation using an X-ray generator (Moxtek Mini tube, tungsten (W) target, 4 W), similar to the photoluminescence under UV excitation. The RL spectra of the three compounds were recorded using a fluorescence spectrophotometer coupled with the X-ray generator, as shown in FIG. 3c. Similar to the photoluminescence spectra, the radioluminescence spectra are featureless with peaks at 403 nm, 447 nm, 487 nm for TPA-PD, (TPA-PD)₂ZnCl₂, and BBPZn, respectively. Using a time-correlated single photon counting technique (¹³⁷Cs excitation source, 662 kV), the radioluminescence decay kinetics were studied for the three compounds, which exhibit biexponential decays with average lifetimes of 9.86 ns, 5.24 ns, and 6.78 ns, respectively (FIG. 3d).

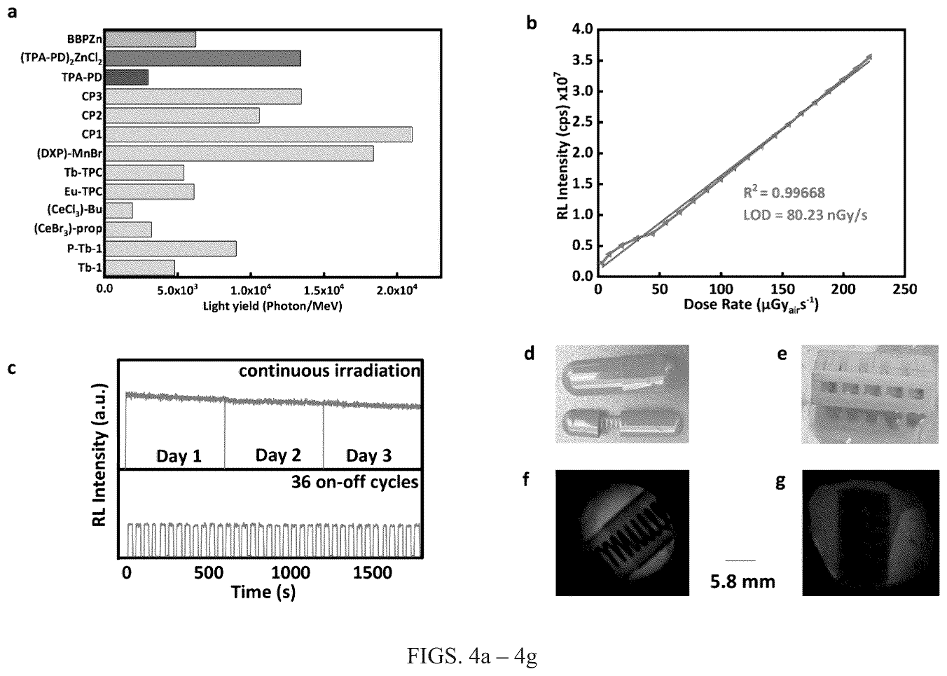

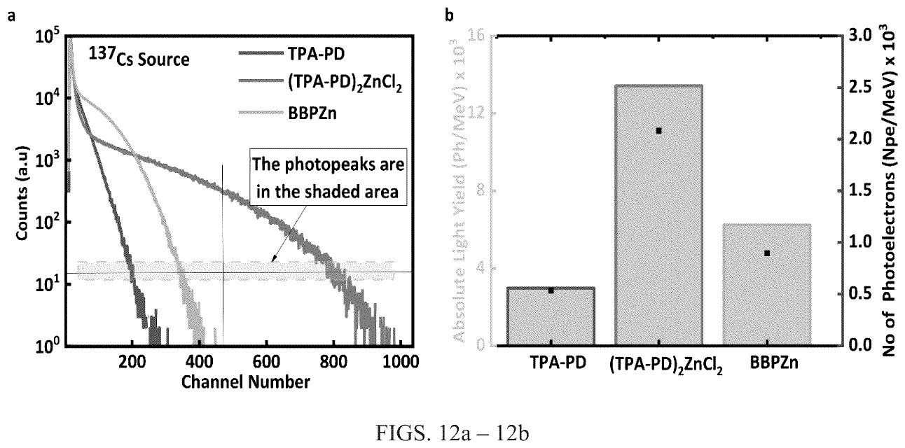

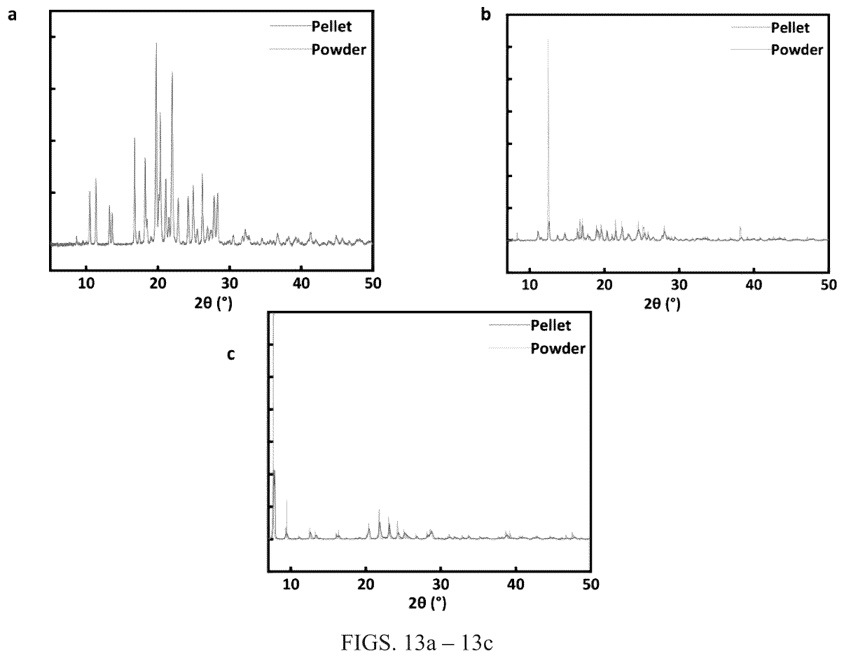

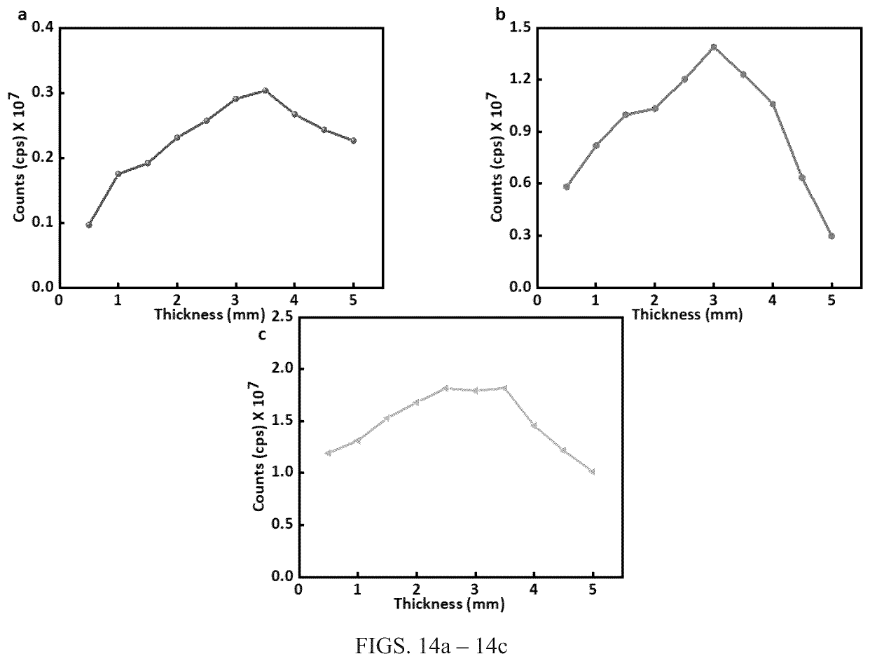

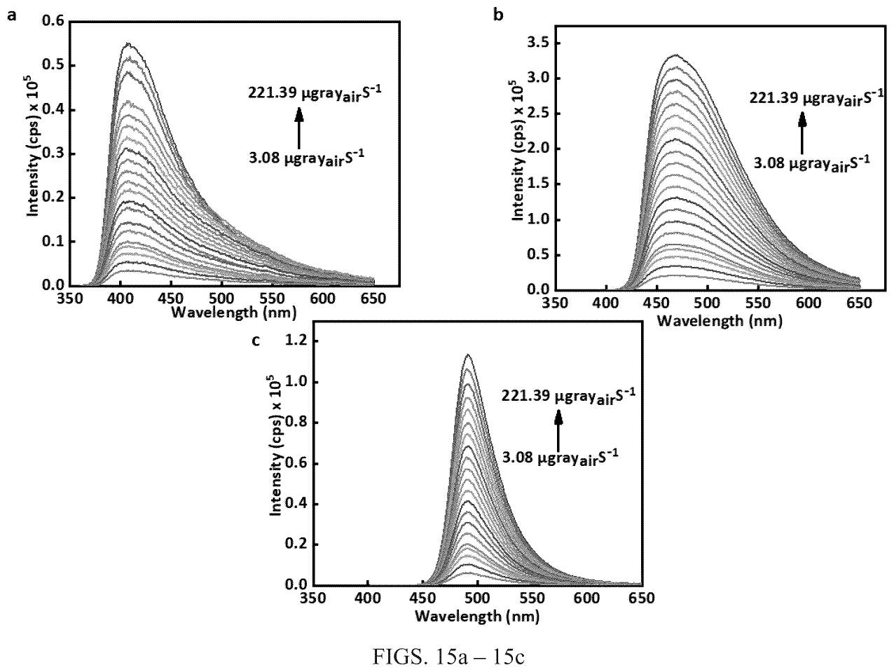

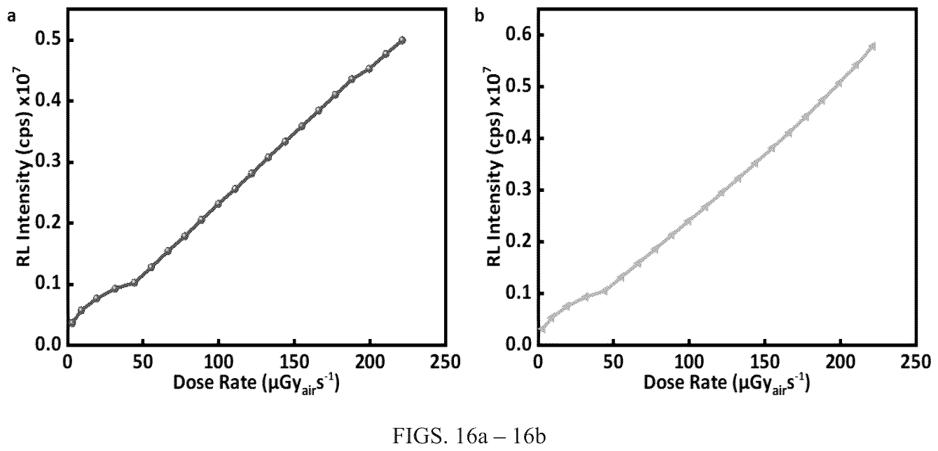

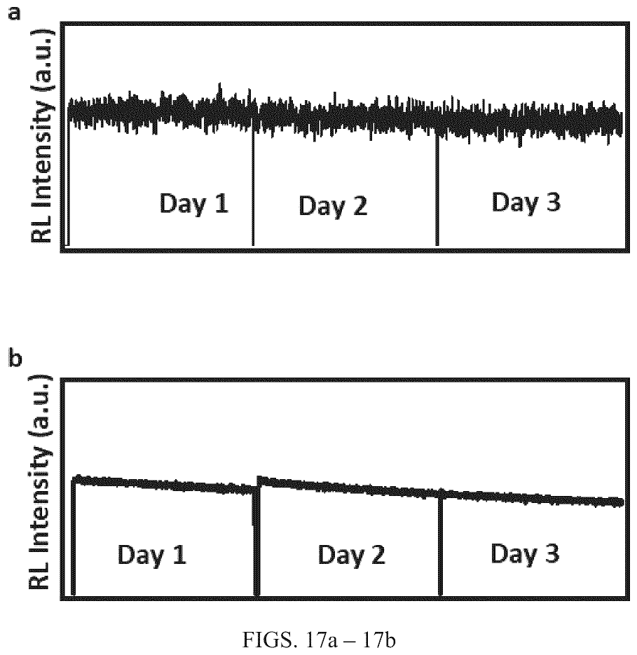

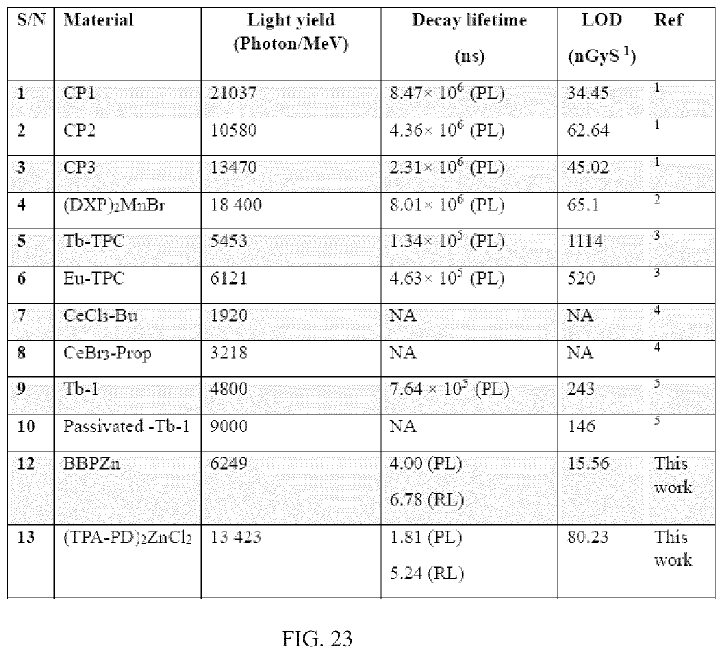

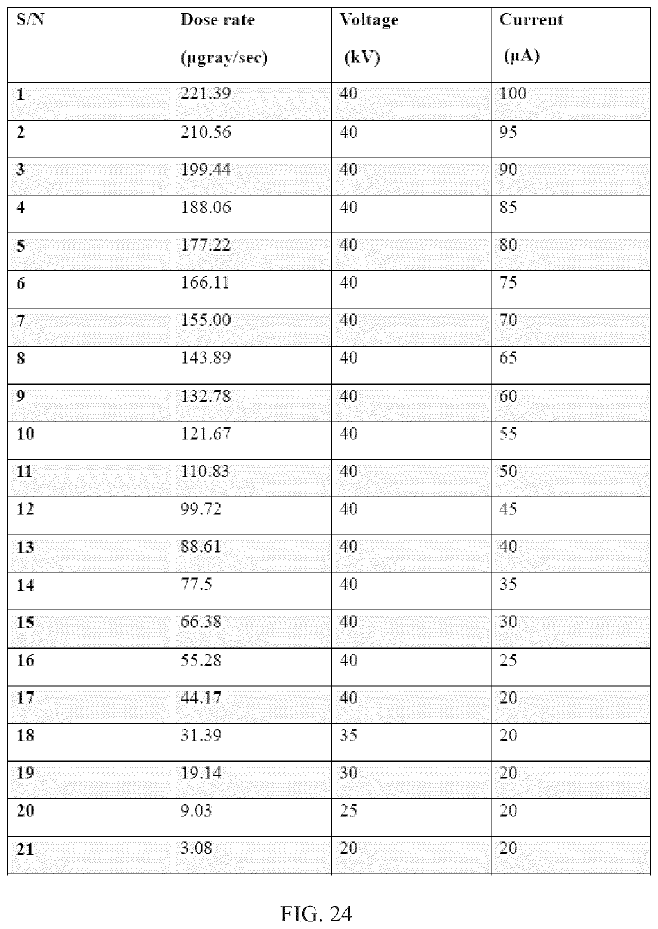

The absolute scintillation light yields of TPA-PD, (TPA-PD)₂ZnCl₂, and BBPZn were determined using the single photoelectron technique with a factory-measured quantum efficiency R2059 Photomultiplier Tube (PMT) (FIGS. 12a and 12b). (TPA-PD)₂ZnCl₂ was found to have an absolute light yield of 13,423 Photon/MeV, which is significantly higher than those of TPA-PD (2980 Photon/MeV) and BBPZn (6249 Photon/MeV). Indeed, (TPA-PD)₂ZnCl₂ has one of the highest absolute light yields among all the organic metal complex scintillators (see also FIG. 4a and the table in FIG. 23). With short RL decay lifetime and high absolute light yield, (TPA-PD)₂ZnCl₂ is highly promising for many applications that require fast responses, such as X-ray dynamic imaging and high-energy physics experiments. In order to measure the thickness-dependent RL, TPA-PD, (TPA-PD)₂ZnCl₂, and BBPZn were made into pellets (0.5 mm-5 mm) with a hydraulic press of 1 metric ton load for 30 seconds. Powder X-ray diffraction spectra of the crystals and pellets show similar results (FIGS. 13a-13c), suggesting phase and structural integrity are maintained. Steady increase of RL responses upon the increasing of pellet thickness can plainly be seen until 3.00 mm (FIGS. 14a and 14b). BBPZn shows RL steady increase up to 3.50 mm (FIG. 14c). The dose linearity was determined by irradiating these materials with X-ray dose rate in a descending dose rate order from 3.08 to 221.39 to 3.08 μGy/s. As shown in FIGS. 4b, 15a-15c, 16a, and 16b, all the samples show excellent response linearities to dose rates. The limit of detection (LOD), an important performance metric, was determined to be 538.04 nGyₐᵢᵣ/s for TPA-PD, 80.23 nGyₐᵢᵣ/s for (TPA-PD)₂ZnCl₂, and 15.56 nGyₐᵢᵣ/s for BBPZn, which are significantly lower than the standard dose for X-ray medical diagnostics (5.5 μGyₐᵢᵣ/s). The radio-stability was investigated with results shown in FIGS. 4c, 17a, and 17b. Under a continuous high dose rate (221.39 μGyₐᵢᵣ/s) irradiation for 30 mins, the RL intensities of TPA-PD and (TPA-PD)₂ZnCl₂ remain at 95%, and BBPZn at 94%, of their initial RL intensities, which are comparable to commercially available plastic scintillators. Moreover, the RL intensity of (TPA-PD)₂ZnCl₂ is stable under repeated X-ray excitation with 36 cycles on and off, as shown in FIG. 4c.

### Example 3

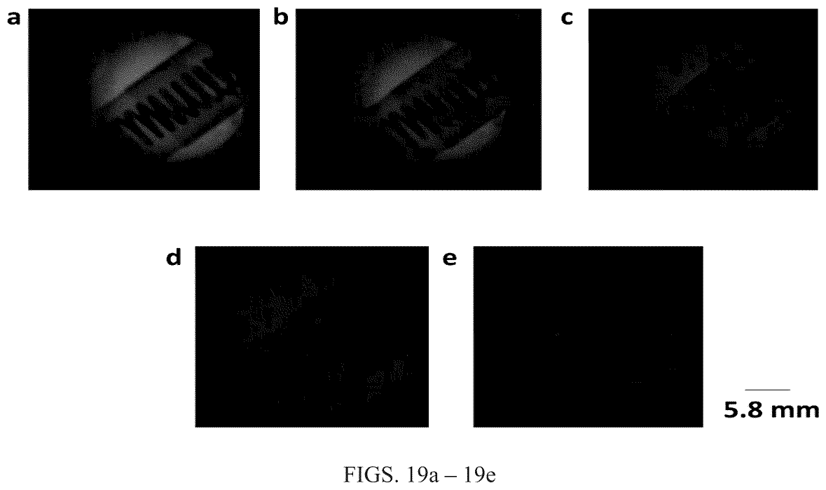

Given the remarkable RL properties of (TPA-PD)₂ZnCl₂, X-ray imaging capability was tested on a 260 μm film of (TPA-PD)₂ZnCl₂ (60 wt %)-PMMA composite (see also FIG. 18a). The composite was mounted on a lab-built X-ray imaging setup (FIG. 18b), comprising an X-ray source, a sample holder for objects (see FIGS. 4d and 4e), a light ray deflector, and a digital camera. FIGS. 4f and 4g show imaging capability of the composite under 221.39 μGy/s. The images obtained reveal the internal structure of the visualized objects with great clarity. Further, FIGS. 19a-19e display the X-ray images produced under various X-ray dose rates, elucidating the (TPA-PD)₂ZnCl₂-PMMA composite's ability to consistently provide clear X-ray images even at low X-ray dose rates. This demonstrates the significant potential of (TPA-PD)₂ZnCl₂ for non-destructive testing.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein (including those in the “References” section, if present) are incorporated by reference in their entirety, including all figures and tables, to the extent they are not inconsistent with the explicit teachings of this specification.

### REFERENCES

1. Shonde, T.B., Chaaban, M., Liu, H., Olasupo, O.J., Ben-Akacha, A., Gonzalez, F.G., Julevich, K., & Lin, X., Winfred, J.S.R.V., Stand, L.M., Zhuravleva, M., Ma, B. Molecular Sensitization Enabled High Performance Organic Metal Halide Hybrid Scintillator. Advanced Materials (2023).
2. Xu, L.J., Lin, X., He, Q., Worku, M., Ma, B. Highly efficient eco-friendly X-ray scintillators based on an organic manganese halide. Nat Commun 11, 4329 (2020).
3. He. Q., Z., C., Xu, L., Lee, S., Lin X., Neu, J., Worku, M., Chaaban, M., and Ma, B. Highly stable organic antimony halide crystals for X-ray scintillation. ACS Materials Lett 2, 633-638 (2020).
4. Shonde, T.B., Mondal, A., Liu, H., Chaaban, M., Ben-Akacha, A., Lee, S., Knorr, E.S., Ma, B. Dramatically enhanced X-ray scintillation of BODIPY via sensitization by an organic metal halide. ACS Materials Letters, 271-276 (2022).
5. Morad, V., Shynkarenko, Y., Yakunin, S., Brumberg, A., Schaller, R. D., Kovalenko, M. V. Disphenoidal Zero-Dimensional Lead, Tin, and Germanium Halides: Highly Emissive Singlet and Triplet Self-Trapped Excitons and X-ray Scintillation. J Am Chem Soc 141, 9764-9768 (2019).
6. Dujardin, C., Auffray, E., Bourret-Courchesne, E., Dorenbos, P., Lecoq, P., Nikl, M., Vasil'ev, A. N., Yoshikawa, A., Zhu, R. Y. Needs, trends, and advances in inorganic scintillators. IEEE Transactions on Nuclear Science 65, 1977-1997 (2018).
7. Maddalena, F., Tjahjana, L., Xie, A., Arramel, Zeng, S., Wang, H., Coquet, P., Drozdowski, W., Dujardin, C., Dang, C., Birowosuto, M. Inorganic, organic, and perovskite halides with nanotechnology for high-light yield X-and y-ray scintillators. Crystals 9, 88 (2019).
8. Ma, W., Su, Y., Zhang, Q., Deng, C., Pasquali, L., Zhu, W., Tian, Y., Ran, P., Chen, Z., Yang, G., Liang, G., Liu, T., Zhu, H., Huang, P., Zhong, H., Wang, K., Peng, S., Xia, J., Liu, H., Liu, X., Yang, Y. M. Thermally activated delayed fluorescence (TADF) organic molecules for efficient X-ray scintillation and imaging. Nat Mater (2021).
9. Mathis Ii, S.R.G., S. T. Bacsa, J. Steiner, A. Ingram, C.W. Doty, F.P. Auden, E. Hattar, K. Mesoporous stilbene-based lanthanide metal organic frameworks: synthesis, photoluminescence and radioluminescence characteristics. Dalton Trans 46, 491-500 (2017).
10. Chen, Q., Wu, J., Ou, X., Huang, B., Almutlaq, J., Zhumekenov, A.A., Guan, X., Han, S., Liang, L., Yi, Z., Li, J., Xie, X., Wang, Y., Li, Y., Fan, D., Teh, D. B. L., All, A.H., Mohammed, O.F., Bakr, O. M. Wu, T., Bettinelli, M., Yang, H., Huang, W., Liu, X. All-inorganic perovskite nanocrystal scintillators. Nature 561, 88-93 (2018).
11. Zhu, W., Ma, W., Su, Y., Chen, Z., Chen, X., Ma, Y., Bai, L., Xiao, W., Liu, T., Zhu, H., Liu, X., Liu, H., Liu, X., Yang, Y. M. Low-dose real-time X-ray imaging with nontoxic double perovskite scintillators. Light Sci Appl 9, 112 (2020).
12. Nagarkar, V.V. et al. Structured CsI (TI) scintillators for X-ray imaging applications. IEEE Transactions on Nuclear Science 45, 492-496 (1998).
13. S. Baccaro, K.B., F. de Notaristefani, P. Mally, J.A. Mares, R. Pani, R. Pellegrini, A. Soluri Scintillation properties of YAP: Ce. Nucl. Instru. and Meth. in Phys. Res A, 209-215 (1995).
14. Wang, J.-X., Gutiérrez-Arzaluz, L., Wang, X., Almalki, M., Yin, J., Czaban-Jóźwiak, J., Shekhah, O., Zhang, Y., Bakr, O. M., Eddaoudi, M., Mohammed, O.F. Nearly 100% energy transfer at the interface of metal-organic frameworks for X-ray imaging scintillators. Matter 5, 253-265 (2022).
15. Hajagos, T.J., Liu, C., Cherepy, N.J., Pei, Q. High-Z sensitized plastic scintillators: a review. Adv Mater 30, e1706956 (2018).
16. Koshimizu, M. Recent progress of organic scintillators. Japanese Journal of Applied Physics 62 (2022).
17. Liu, X., Li, R., Xu, X., Jiang, Y., Zhu, W., Yao, Y., Li, F., Tao, X., Liu, S., Huang, W., Zhao, Q. Lanthanide (III)-Cu(4) I(4) Organic Framework Scintillators Sensitized by Cluster-Based Antenna for High-Resolution X-ray Imaging. Adv Mater 35, e2206741 (2023).
18. Gandini, M., Villa, I., Beretta, M., Gotti, C., Imran, M., Carulli, F., Fantuzzi, E., Sassi, M., Zaffalon, M., Brofferio, C., Manna, L., Beverina, L., Vedda, A., Fasoli, M., Gironi, L., Brovelli, S. Efficient, fast and reabsorption-free perovskite nanocrystal-based sensitized plastic scintillators. Nat Nanotechnol 15, 462-468 (2020).
19. Lu, J., Xin, X. H., Lin, Y.J., Wang, S.H., Xu, J.G., Zheng, F.K., Guo, G.C. Efficient X-ray scintillating lead (ii)-based MOFs derived from rigid luminescent naphthalene motifs. Dalton Trans 48, 1722-1731 (2019).
20. Perego, J., Bezuidenhout, C.X., Villa, I., Cova, F., Crapanzano, R., Frank, I., Pagano, F., Kratochwill, N., Auffray, E., Bracco, S., Vedda, A., Dujardin, C., Sozzani, P.E., Meinardi, F., Comotti, A., Monguzzi, A. Highly luminescent scintillating hetero-ligand MOF nanocrystals with engineered Stokes shift for photonic applications. Nat Commun 13, 3504 (2022).
21. Dumur, F. Zinc complexes in OLEDs: An overview. Synthetic Metals 195, 241-251 (2014).
22. Boatner, L.A., Neal, J.S., Ramey, J.O., Chakoumakos, B.C., Custelcean, R., van Loef, E.V.D., Markosyan, G., Shah, K.S. New cerium-based metal-organic scintillators for radiation detection. Nuclear Instruments and Methods in Physics Research Section A: Accelerators, Spectrometers, Detectors and Associated Equipment 703, 138-144 (2013).
23. Chen, Z., Lu, D., Xie, H., Yang, X., Li, Y., Bao, C., Lei, L., Xu, S. Triplet Exciton Enhanced Radioluminescence of Ga3+/Tb 3+ Metallacrown Scintillators for X-Ray Detection. Advanced Optical Materials 10, 2102074 (2021).
24. Ma, Y., Zhuang, Z., Xing, L., Li, J., Yang, Z., Ji, S., Hu, R., Zhao, Z., Huo, Y., Tang, B. Z. The AIE-Active Dual-Cationic Molecular Engineering: Synergistic Effect of Dark Toxicity and Phototoxicity for Anticancer Therapy. Advanced Functional Materials, 2106988 (2021).
25. Yin, P., Wang, T., Yang, Y., Yin, W., Zhang, S., Yang, Z., Qi, C., Ma, H. Positive charge-dependent cell targeted staining and DNA detection. New Journal of Chemistry 43, 18251-18258 (2019).
26. Xiong, S., Xiong, Y., Wang, D., Pan, Y., Chen, K., Zhao, Z., Wang, D., Tang, B., Z. Achieving Tunable Organic Afterglow and UV Irradiation-Responsive Ultralong Room-Temperature Phosphorescence from Pyridine-Substituted Triphenylamine Derivatives. Advanced Materials (2023).
27. Geng, R., Hou, X., Sun, Y., Yan, C., Wu, Y., Zhang, H.-L., Shao, X. Driving x-plane to T-bowl through lateral coordination at room temperature. Materials Chemistry Frontiers 2, 1456-1461 (2018).
28. Zheng, Z., Opilik, L., Schiffmann, F., Liu, W., Bergamini, G., Ceroni, P., Lee, L.-T., Schütz, A., Sakamoto, J., Zenobi, R., Vandevondele, J., Schlüter, A. D. Synthesis of Two-Dimensional Analogues of Copolymers by Site-to-Site Transmetalation of Organometallic Monolayer Sheets. Journal of the American Chemical Society 136, 6103-6110 (2014).
29. Zavaleta, A., Lykhin, A.O., Monteiro, J. H. S. K., Uchida, S., Bell, T.W., De Bettencourt-Dias, A., & Varganov, S.A., Gallucci, J. Full Visible Spectrum and White Light Emission with a Single, Input-Tunable Organic Fluorophore. Journal of the American Chemical Society 142, 20306-20312 (2020).
30. Zhou, Z., Meng, H., Li, F., Jiang, T., Yang, Y., Liu, S., Zhao, Q. Highly Luminescent Nonclassical Binuclear Manganese (II) Complex Scintillators for Efficient X-ray Imaging. Inorg Chem 62, 5729-5736 (2023).
31. Meng, H., Zhu, W., Li, F., Huang, X., Qin, Y., Liu, S., Yang, Y., Huang, W., Zhao, Q. Highly Emissive and Stable Five-Coordinated Manganese (II) Complex for X-Ray Imaging. Laser &amp; Photonics Reviews 15, 2100309 (2021).
32. Liu, X., Wang, S., Xie, W., Ni, J., Xiao, K., Liu, S., Lv, W., Zhao, Q. Rational design and synthesis of scintillating lanthanide coordination polymers for highly efficient X-ray imaging. Journal of Materials Chemistry C 11, 7405-7410 (2023).
33. Wang, X., Shi, H., Ma, H., Ye, W., Song, L., Zan, J., Yao, X., Ou, X., Yang, G., Zhao, Z., Singh, M., Lin, C., Wang, H., Jia, W., Wang, Q., Zhi, J., Dong, C., Jiang, X., Tang, Y., Xie, X., Yang, Y., Wang, J., Chen, Q., Wang, Y., Yang, H., Zhang, G., An, Z., Liu, X., Huang, W. Organic phosphors with bright triplet excitons for efficient X-ray-excited luminescence. Nature Photonics 15, 187-192 (2021).

What is claimed is:

1. A scintillation material, comprising:
an organic metal halide complex comprising an aggregate induced emission (AIE) organic species and a metal halide species,
wherein the metal halide is a radiation absorber, and
wherein the AIE organic species is as a light emitter.

2. The scintillation material according to claim 1, wherein the metal halide species is represented by the formula MₐX_{b}, where M is a metal, X is a halogen, and a and b are integers.

3. The scintillation material according to claim 1, wherein the metal halide species is ZnCl₂.

4. The scintillation material according to claim 1, wherein the organic metal halide complex is represented by the formula (OMM)ₘZ(MₐX_{b})ₙ, where OMM is the AIE organic species, M is a metal, X is a halogen, and a, b, m, and n are integers, and
wherein OMM and MₐX_{b} are covalently bonded to each other to form the organic metal halide complex.

5. The scintillation material according to claim 1, wherein the AIE organic species is 4-(4-(diphenylamino) phenyl)-1-(propyl)-pyridinium (TPA-PD), and
wherein the organic metal halide complex is (TPA-PD)₂ZnCl₂.

6. The scintillation material according to claim 1, wherein the scintillation material has a photoluminescence quantum efficiency (PLQE) of at least 65%.

7. The scintillation material according to claim 1, wherein the scintillation material has an absolute light yield of at least 13,423 photons per mega electron Volt (photon/MeV).

8. The scintillation material according to claim 1, wherein the scintillation material has a limit of detection of about 80 nanoGrays per second (nGyₐᵢᵣ/s).

9. The scintillation material according to claim 1, wherein the scintillation material has a radioluminescence decay lifetime in a range of from 1 nanoseconds (ns) to 100 ns.

10. An X-ray imaging material, comprising:
a composite of a polymer and the scintillation material according to claim 1.

11. The X-ray imaging material according to claim 10, wherein the polymer is poly (methyl methacrylate) (PMMA).

12. A method of fabricating a scintillation material comprising an organic metal halide complex, the method comprising:
synthesizing an aggregate induced emission (AIE) organic species;
mixing the AIE organic species with a metal halide species in a solvent to obtain a precursor solution; and
performing solvent layering of an organic liquid on the precursor solution to obtain the organic metal halide complex.

13. The method according to claim 12, wherein the organic liquid is acetonitrile.

14. The method according to claim 12, wherein the metal halide species is represented by the formula MₐX_{b}, where M is a metal, X is a halogen, and a and b are integers.

15. The method according to claim 12, wherein the metal halide species is ZnCl₂.

16. The method according to claim 12, wherein the organic metal halide complex is represented by the formula (OMM)ₘ(MₐX_{b})ₙ, where OMM is the AIE organic species, M is a metal, X is a halogen, and a, b, m, and n are integers.

17. The method according to claim 12, wherein the AIE organic species is 4-(4-(diphenylamino)phenyl)-1-(propyl)-pyridinium (TPA-PD), and
wherein the organic metal halide complex is (TPA-PD)₂ZnCl₂.

18. The method according to claim 12, wherein the scintillation material has a photoluminescence quantum efficiency (PLQE) of at least 65%, and
wherein the scintillation material has an absolute light yield of at least 13,423 photons per mega electron Volt (photon/MeV).

19. The method according to claim 12, wherein the scintillation material has a limit of detection of about 80 nanoGrays per second (nGyₐᵢᵣ/s).

20. The method according to claim 12, wherein the scintillation material has a radioluminescence decay lifetime in a range of from 1 nanoseconds (ns) to 100 ns.
